(19) United States
(12) Patent Application Publication
(10) Pub. No.: US 2025/0292325 A1
(43) Pub. Date: Sep. 18, 2025

(54) Technologies For Lending Behavior Detection

(71) Applicant: The PNC Financial Services Group, Inc., Pittsburgh, PA (US)

(72) Inventors: Aaron Michael Chumsky, Pittsburgh, PA (US); Amanda McCracken, Westerville, OH (US); Thenmozhi Radhakrishnan, McKinney, TX (US); Steven Zinger, Pittsburgh, PA (US); Crystal May, Rocky Mount, NC (US)

(21) Appl. No.: 19/078,352

(22) Filed: Mar. 13, 2025

Related U.S. Application Data
(60) Provisional application No. 63/565,628, filed on Mar. 15, 2024.

(51) Int. Cl. G06Q 40/03

(52) U.S. Cl. CPC G06Q 40/03

(57) ABSTRACT

Technologies for lending behavior detection include a compute device. The compute device includes circuitry configured to obtain financial transaction data indicative of financial transactions associated with one or more lending financial products of a financial institution. The circuitry may also be configured to apply, as a function of a corresponding lending financial product associated with the financial transactions, one or more tests to the obtained financial transaction data to detect risk exposure. Additionally, the circuitry may be configured to generate, in response to a determination that risk exposure has been detected, an alert to enable a human reviewer to evaluate the corresponding financial transaction data.

### RELATED APPLICATIONS

This application claims the benefit of U.S. Provisional Application No. 63/656,628 filed Mar. 15, 2024 for “Technologies for Lending Behavior Detection,” which is hereby incorporated by reference in its entirety.

### BACKGROUND

Financial institutions are subject to an array of government regulations, including regulations oriented towards reducing the likelihood of money laundering and related financial crimes. A given customer's financial transactions may occur anywhere in the world, be processed through any of a variety of payment systems, and may be subject to sophisticated obfuscation techniques designed to evade detection by a human reviewer. The complexity of detecting potential financial crime is exacerbated when the potential activities that could facilitate a financial crime vary based on the financial product type involved. As such, for large financial institutions that provide a variety of financial products, such as various forms of lending products, to a vast customer base that may include individuals and/or organizations, ensuring compliance with financial crime regulations is a significant technical challenge.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for performing lending behavior detection;

FIG. 2 is a simplified block diagram of at least one embodiment of a compute device of the system of FIG. 1;

FIGS. 3-6 are simplified block diagrams of at least one embodiment of a method for performing lending behavior detection that may be executed by the system of FIG. 1;

FIG. 7 is a table indicative of tests that may be applied to financial transaction data by the system of FIG. 1 for each of multiple financial products; and

FIGS. 8-17 are simplified block diagrams of embodiments of tests for detecting scenarios indicative risk exposure for a lender that may be performed by the system of FIG. 1 in connection with the method of FIGS. 3-6.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

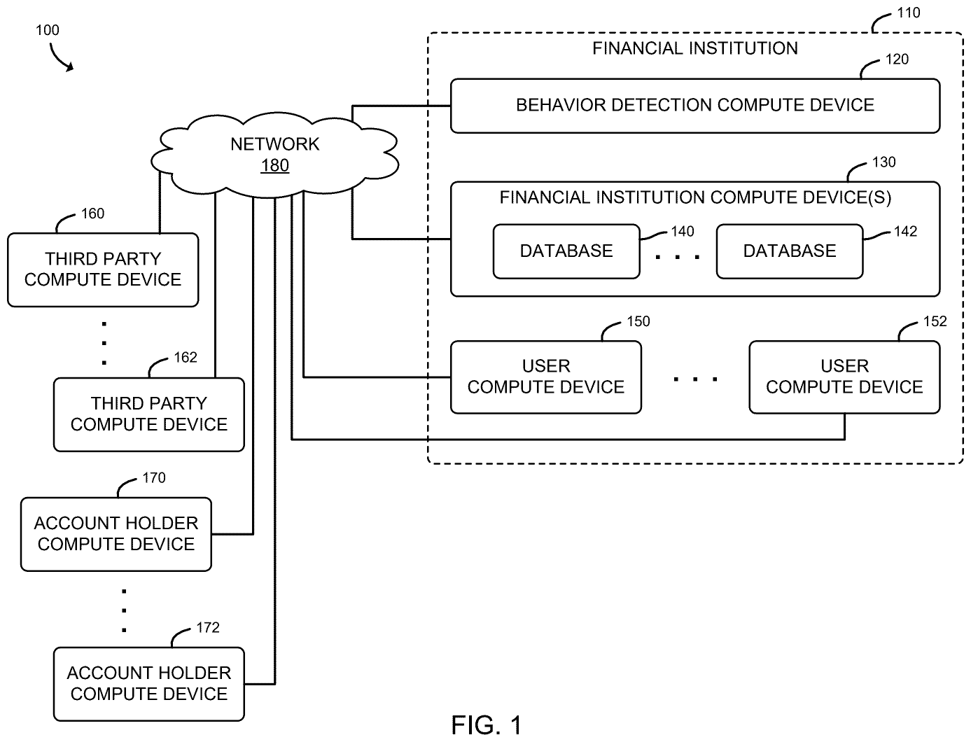

Referring now to FIG. 1, a system 100 for performing lending behavior detection includes, in the illustrative embodiment, a behavior detection compute device 120 communicatively connected to a set of one or more financial transaction compute devices 130 which operate to process financial transactions and store data pertaining to those financial transactions, the financial products (e.g., lending products) and customers (e.g., individuals, organizations, etc.) of the financial institution 110 in databases 140, 142. The system 100 also includes user computer devices 150, 152 which may be utilized by personnel associated with the financial institution 110 to view data pertaining to the financial transactions, customers, financial products, and alerts that may be produced by the behavior detection compute device 120 as described in more detail herein. In addition, the system 100 includes third party compute devices 160, 162 which may be embodied as any devices utilized by parties other than the financial institution 110 to initiate or process financial transactions (e.g., point of sale devices, credit card network devices, electronic commerce platforms, digital payment platforms, etc.), and/or provide supplemental data (e.g., due diligence data associated with Know Your Customer (KYC) regulations or the like) utilized by the behavior detection compute device 120 and/or the financial institution compute devices 130 in carrying out operations. Additionally, the system 100 includes account holder compute devices 170, 172 which may be embodied as any devices utilized by customers (e.g., individuals, organizations, etc.) of the financial institution 110 who may utilize one or more lending products of the financial institution 110 and hold corresponding financial accounts with the financial institution 110.

In the illustrative embodiment, the behavior detection compute device 120, in operation, analyzes data indicative of financial transactions involving customers of the financial institution 110 to determine whether the financial institution 110 may be exposed to risk of financial crime (e.g., money laundering), with respect to financial products (e.g., loans or lines of credit) provided by the financial institution 110. In doing so, the behavior detection compute device 120 applies one or more tests based on corresponding defined thresholds that, when met or exceeded (e.g., satisfied), may indicate that the corresponding customer (e.g., individual, organization, etc.) is engaged in a financial crime. As described in more detail herein, the tests are defined to detect the presence of scenarios (e.g., activities or behaviors) that may enable, contribute to, or otherwise facilitate financial crimes such as money laundering. In doing so, the behavior detection compute device 120 selects tests to apply based on the financial product in question and applies corresponding thresholds that may vary based on attributes of the customer (e.g., individual vs. organization, geographic location of the customer, risk ranking from KYC due diligence data), and/or attributes of other parties to the financial transactions (e.g., types of business operations of merchants with which the customer has transacted with). In the illustrative embodiment, in instances in which the behavior detection compute device 120 determines that a scenario may be present (e.g., all applicable thresholds associated with a corresponding test have been satisfied), the behavior detection compute device 120 produces an alert (e.g., data indicative of the detected scenario) to be routed to a corresponding user (e.g., a human analyst operating one of the user compute devices 150, 152) for review. The user may then review the underlying data that caused the alert and potentially prepare a report of the activity for a government authority (e.g., in a suspicious activity report (SAR)) in accordance with banking regulations. Given the variety of customer types, range of lending products, and volume of transactions occurring throughout the world with counterparties having differing levels of risk, human review and comprehension of such data is impracticable. As such, and unlike conventional systems, the system 100 addresses the fundamental technological problem of detecting potential financial crime across those transactions and presenting alerts for use by personnel of the financial institution 110.

Though a relatively small set of compute devices 120, 130, 150, 152, 160, 162, 170, 172 are shown in FIG. 1 for simplicity and clarity, it should be understood that the number of compute devices, in practice, may range in the tens, hundreds, thousands, or more. Likewise, it should be understood that the compute devices 120, 130, 150, 152, 160, 162, 170, 172 may be distributed differently or perform different roles than the configuration shown in FIG. 1. Further, though shown as separate compute devices 120, 130, 150, 152, 160, 162, 170, 172 in some embodiments, the functionality of one or more of the compute devices 120, 130, 150, 152, 160, 162, 170, 172 may be combined into fewer compute devices (the behavior detection compute device 120 may be combined with the financial institution compute device(s) 130) and/or distributed across more compute devices than those shown in FIG. 1 (e.g., the behavior detection compute device 120 may comprise multiple compute devices and/or the financial transaction compute devices 130 may comprise any number of compute devices).

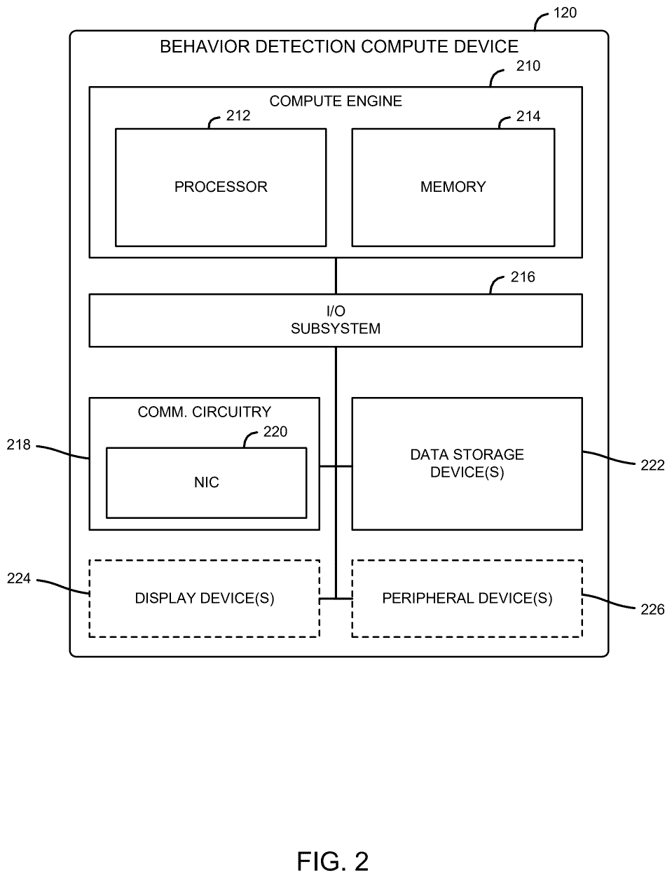

Referring now to FIG. 2, the illustrative behavior detection compute device 120 includes a compute engine 210, an input/output (I/O) subsystem 216, communication circuitry 218, and one or more data storage devices 222. In some embodiments, the behavior detection compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the behavior detection compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as financial transaction data, customer risk ratings, risk thresholds, applications, libraries, and drivers.

The compute engine 210 is communicatively coupled to other components of the behavior detection compute device 120 via the I/O subsystem 216, which may be embodied as circuitry and/or components to facilitate input/output operations with the compute engine 210 (e.g., with the processor 212 and the main memory 214) and other components of the behavior detection compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the behavior detection compute device 120, into the compute engine 210.

The communication circuitry 218 may be embodied as any communication circuit, device, or collection thereof, capable of enabling communications over a network between the behavior detection compute device 120 and another device (e.g., a compute device 130, 150, 152, 160, 162, 170, 172, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the behavior detection compute device 120 to connect with another compute device (e.g., a compute device 130, 150, 152, 160, 162, 170, 172 etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the behavior detection compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the behavior detection compute device 120 are housed in a single unit. However, in other embodiments, the components may be in separate housings, in separate racks of a data center, and/or spread across multiple data centers or other facilities. The compute devices 130, 150, 152, 160, 162, 170, 172 may have components similar to those described in FIG. 2 with reference to the behavior detection compute device 120. The description of those components of the behavior detection compute device 120 is equally applicable to the description of components of the compute devices 130, 150, 152, 160, 162, 170, 172. Further, it should be appreciated that any of the devices 120, 130, 150, 152, 160, 162, 170, 172 may include other components, sub-components, and devices commonly found in a computing device, which are not discussed above in reference to the behavior detection compute device 120 and not discussed herein for clarity of the description.

In the illustrative embodiment, the compute devices 120, 130, 150, 152, 160, 162, 170, 172, are in communication via a network 180, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

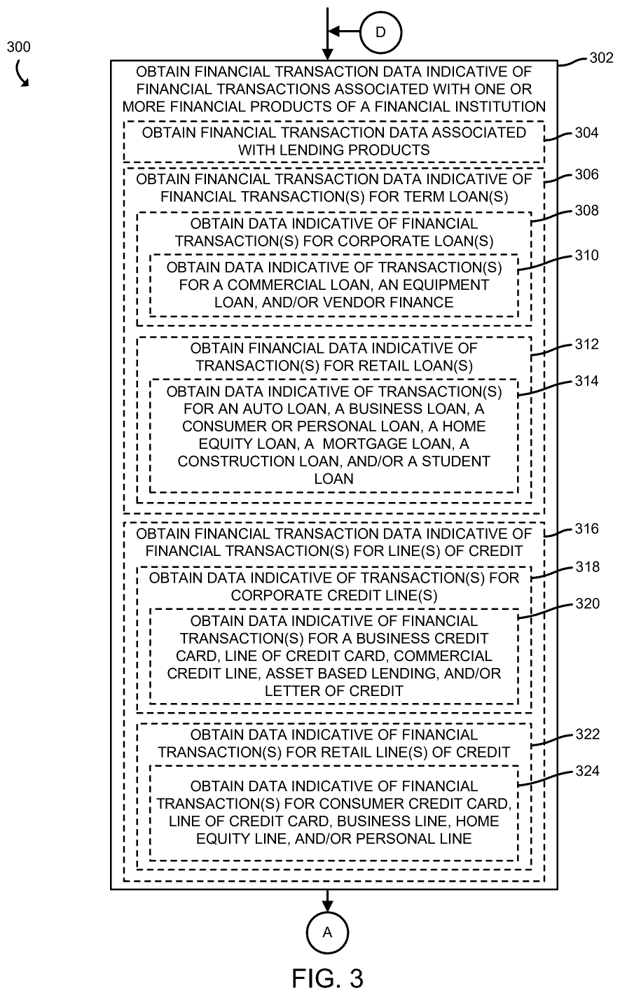

Referring now to FIG. 3, the system 100, and more specifically, the behavior detection compute device 120, in the illustrative embodiment, may perform a method 300 for detecting behaviors of customers, and in particular, behaviors that may be indicative of financial crime in connection with lending products of the financial institution 110. The method 300 begins with block 302 in which the behavior detection compute device 120 obtains (e.g., from the financial transaction compute devices 130, which may retrieve the data from one or more of the databases 140, 142) financial transaction data indicative of financial transactions associated with the financial institution 110. In doing so, in the illustrative embodiment, the behavior detection compute device 120 obtains financial transaction data associated with lending products, as indicated in block 304. As indicated in block 306, the behavior detection compute device 120 may obtain financial transaction data indicative of one or more financial transactions for one or more term loans. For example, and as indicated in block 308, the behavior detection compute device 120 may obtain financial transaction data indicative of one or more financial transactions for a corporate loan. In doing so, the behavior detection compute device 120 may obtain financial transaction data indicative of one or more financial transactions for a commercial loan, an equipment loan, and/or vendor finance, as indicated in block 310.

Additionally or alternatively, the behavior detection compute device 120 may obtain financial data indicative of one or more financial transactions for one or more retail loans, as indicated in block 312. In doing so, the behavior detection compute device 120 may obtain financial data indicative of one or more transactions for an auto loan, a business loan, a consumer or personal loan, a home equity loan, a mortgage loan, a construction loan, and/or a student loan, as indicated in block 314. Further, the behavior detection compute device 120 may obtain financial transaction data indicative one or more financial transactions for one or more lines of credit, as indicated in block 316. In doing so, the behavior detection compute device 120 may obtain financial transaction data indicative of one or more transactions for one or more corporate lines of credit, as indicated in block 318. For example, and as indicated in block 320, the behavior detection compute device 120 may obtain data indicative of one or more financial transactions for a business credit card, a line of credit card, a commercial credit line, asset based lending, and/or a letter of credit. The behavior detection compute device 120 may obtain financial transaction data indicative of one or more financial transactions for one or more retail lines of credit, as indicated in block 322. For example, and as indicated in block 324, the behavior detection compute device 120 may obtain financial transaction data indicative of one or more financial transactions for a consumer credit card, a line of credit card, a business line, a home equity line, and/or a personal line of credit.

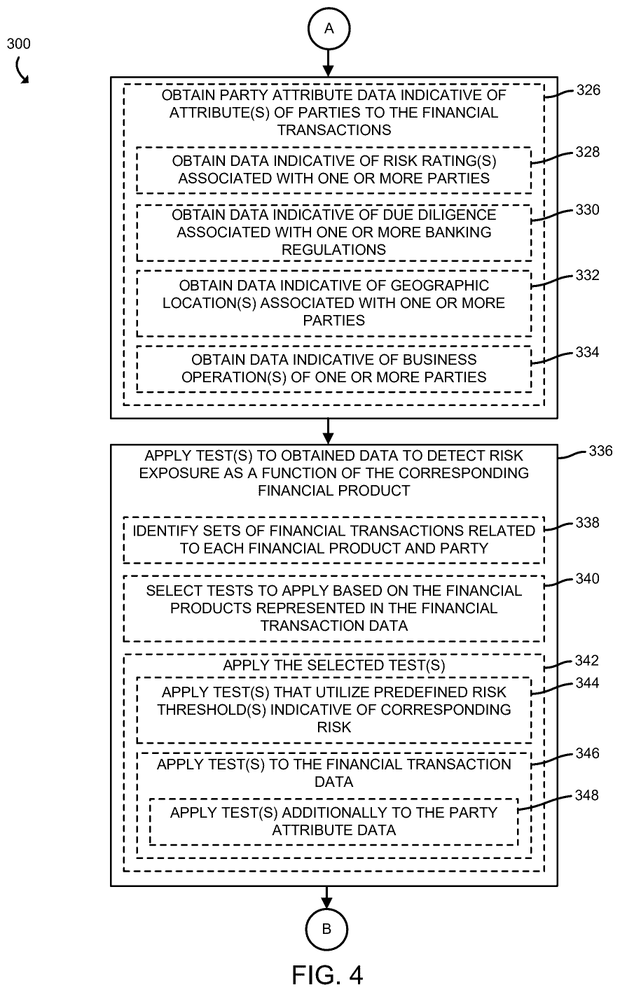

Referring now to FIG. 4, the behavior detection compute device 120 may additionally obtain party attribute data which may be embodied as any data indicative of one or more attributes of parties to the financial transactions (e.g., the financial transactions represented in the financial transaction data from block 302), as indicated in block 326. As indicated in block 328, in obtaining the party attribute data, the behavior detection compute device 120 may obtain data indicative of one or more risk ratings (e.g., a numeric score, a string such as “high”, “medium”, or “low”, or other data indicative of a measure of risk) associated with one or more of the parties. As indicated in block 330, the behavior detection compute device 120 may obtain data indicative of due diligence associated with one more banking regulations. The behavior detection compute device 120 may obtain the data in block 328 and/or block 330 from one or more of the databases 140, 142 and/or from a third party (e.g., from one of the third party compute devices 160, 162, which may be operated by Fenergo or another provider of risk rating and/or due diligence information, such as due diligence associated with Know Your Customer (KYC) regulations). The behavior detection compute device 120 may also obtain data indicative of geographic locations associated with one or more parties to the financial transactions, as indicated in block 332 and/or may obtain data indicative of business operations of one or more of the parties (e.g., goods and services sold by a merchant), as indicated in block 334.

Subsequently, the behavior detection compute device 120 applies one or more tests to the obtained data (e.g., the financial transaction data, party attribute data, etc. from the preceding operations) to detect risk exposure for the financial institution 110, as a function of (e.g., based on) the corresponding financial product (e.g., each corresponding product associated with the financial transactions), as indicated in block 336. In doing so, the behavior detection compute device 120 may identify sets of financial transactions related to each financial product and each party, as indicated in block 338. The behavior detection compute device 120 may identify related financial transactions (e.g., to be identified as a corresponding set) based on data fields associated with records of transactions within the financial transaction data, such as account numbers associated with corresponding financial products of the financial institution 110 and/or names of parties to the transactions. As indicated in block 340, the behavior detection compute device 120 selects tests to apply based on the corresponding financial products represented in the financial transaction data. For example, the behavior detection compute device 120 may look up (e.g., in a table or other data structure in the data storage 222) a set of one or more tests associated with an identifier of a financial product (e.g., from the financial products described in connection with blocks 306 through 324) and select those as the test(s) to apply.

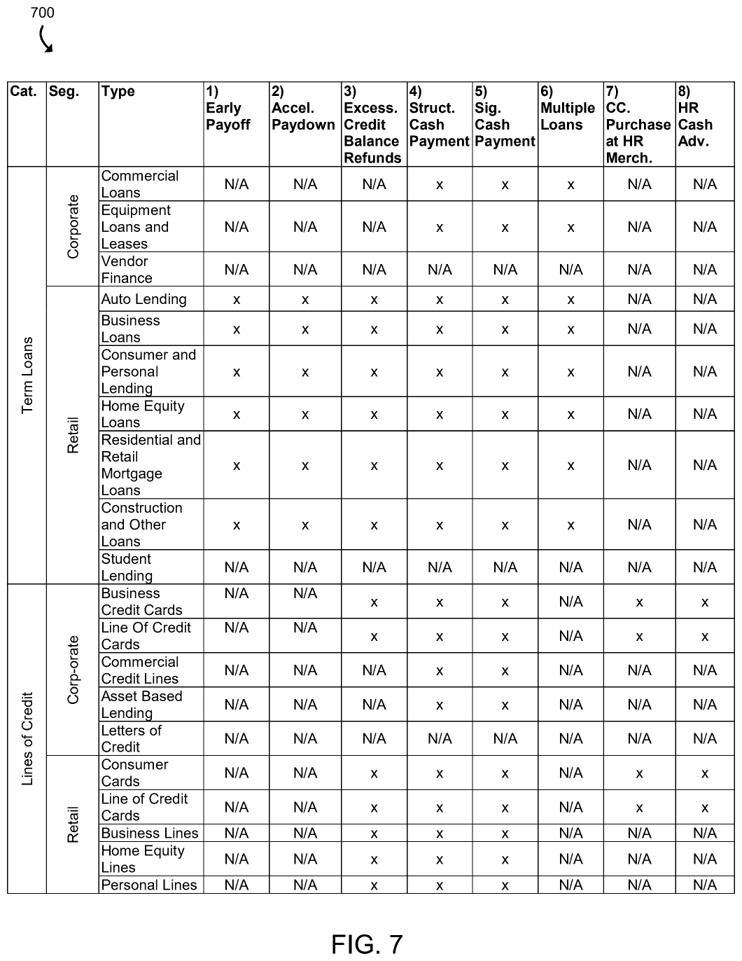

In block 342, the behavior detection compute device 120 applies the selected one or more tests. In doing so, in the illustrative embodiment, the behavior detection compute device 120 applies one or more tests that utilize predefined risk thresholds (which may be adjusted, as described herein) indicative of corresponding risk, as indicated in block 344. The behavior detection compute device 120, in the illustrative embodiment, applies the one or more tests to the financial transaction data, as indicated in block 346. In some embodiments, the behavior detection compute device 120 may apply one or more of the tests to the party attribute data (e.g., if thresholds within the test(s) pertain to one or more party attributes), as indicated in block 348. Referring briefly to FIG. 7, a table 700 indicates tests that may be applied by the behavior detection compute device 120 for each financial product. The tests are described in more detail below. For simplicity and clarity, the following operations are described relative to a single set of transactions for a single financial product associated with a single customer. However, it should be understood that, in operation, the behavior detection compute device 120 applies the following operations for each financial product for each customer represented in the financial transaction data.

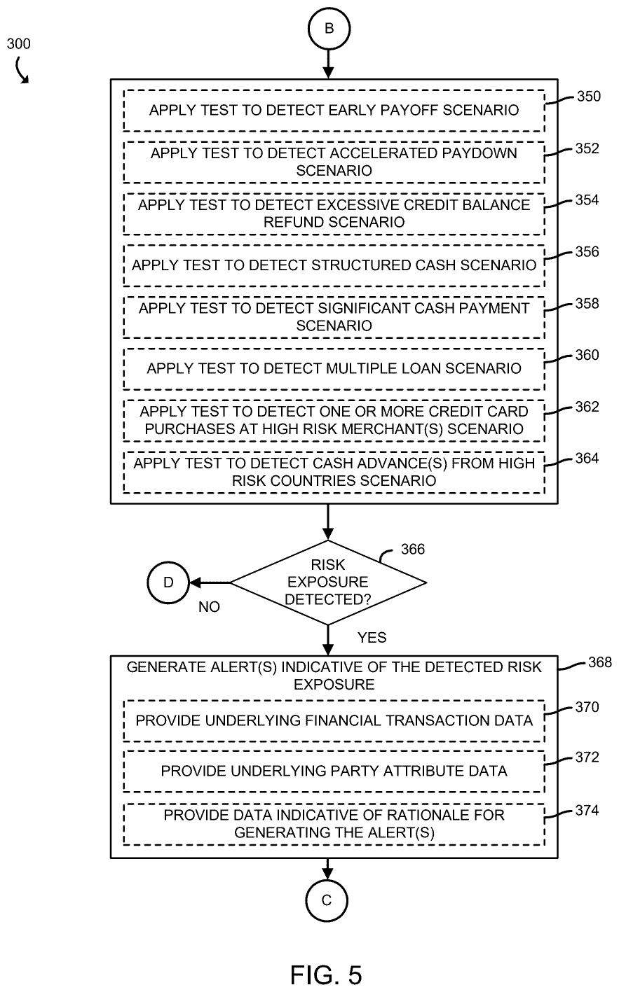

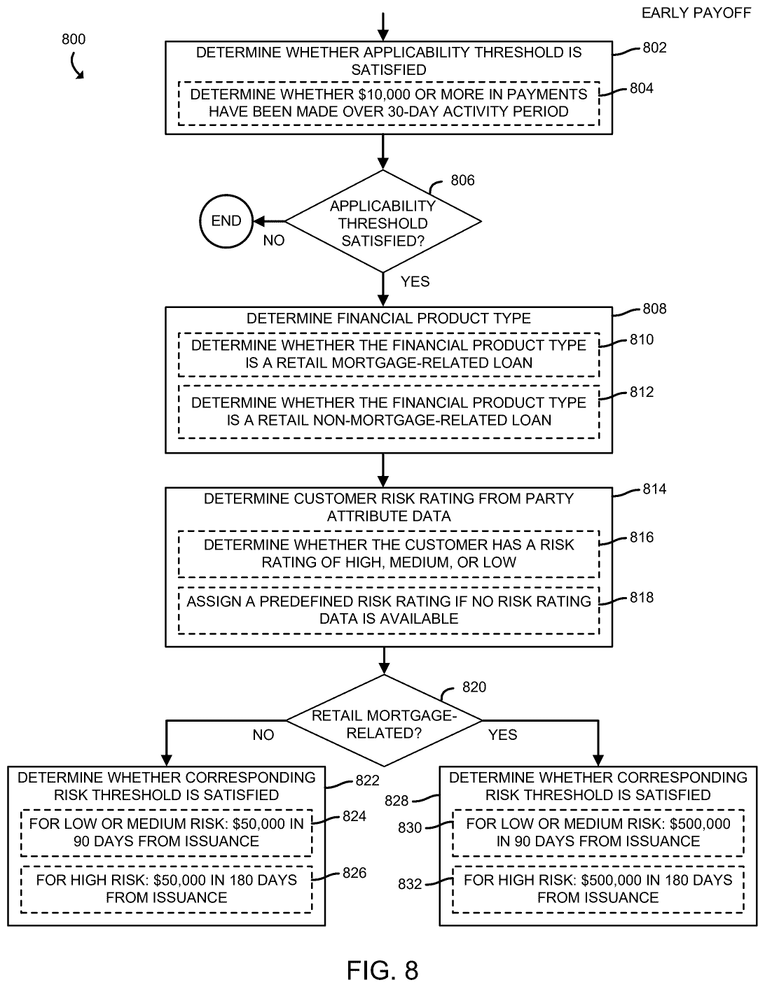

Referring now to FIG. 5, the behavior detection compute device 120 may apply a test to detect an early payoff scenario (e.g., if the one or more financial transactions in the financial transaction data correspond to a lending financial product associated with the early payoff scenario in the table 700, such as a retail term loan other than a student loan). Referring briefly to FIG. 8, an embodiment of the test 800 for the early payoff scenario is directed at identifying a customer paying off a loan in a time period that is unexpectedly shorter than the specified maturity date of that loan. Paying off large dollar amounts on loans in a shorter time frame than the specified maturity date can be used as a method to aid in the placement, layering, and integration of illicit funds. As such, the test 800 identifies accounts that have substantial risk because of the placement of relatively large illegitimate funds into the banking system to pay off and purchase assets.

In the illustrative embodiment, the test 800 focuses on the account level and is applied on a monthly basis, with a one month lookback (e.g., in which the loan was paid off) plus the prior 30-day activity period (e.g., for each customer, payments from the date the loan was paid off plus the prior 30-day activity). In performing the test 800 (e.g., method), the behavior detection compute device 120 initially determines whether a given set of transactions associated with a lending product to which the test applies (e.g., a retail loan, according to the table 700), satisfies an applicability threshold (e.g., a floor), as indicated in block 802. In doing so, in the illustrative embodiment, the behavior detection compute device 120 determines whether the financial transactions indicate that $10,000 or more in payments have been made (e.g., by the customer) over a 30-day activity period, as indicated in block 804. In the illustrative embodiment, the $10,000 threshold (e.g., floor) excludes a population of accounts in which scheduled payments are made approaching the end of a term loan.

In block 806, the behavior detection compute device 120 determines the subsequent course of action based on the result from block 802. That is, if the applicability threshold was not satisfied, the behavior detection compute device 120 ends the test 800. Otherwise (e.g., if the applicability threshold was satisfied), the test 800 proceeds to block 808, in which the behavior detection compute device 120 determines the specific type of financial product type to which the payments were made. In doing so, the behavior detection compute device 120 determines whether the financial product type is a retail mortgage-related loan, as indicated in block 810. If not, and as indicated in block 812, the behavior detection compute device 120 determines whether the financial product type is a retail non-mortgage related loan (e.g., a retail loan that is not related to a mortgage), as indicated in block 814. The behavior detection compute device 120 may make the above determinations by comparing the account number associated with the financial transactions to financial product data associated with the account (e.g., in one or more of the databases 140, 142).

In performing the test 800, the behavior detection compute device 120 also determines a risk rating associated with the customer (e.g., a customer risk rating) from the party attribute data (e.g., obtained in block 328), as indicated in block 814. In doing so, the behavior detection compute device 120 determines whether the customer has a risk rating of high, medium, or low, as indicated in block 816. In instances in which no risk rating data is available for the customer, the behavior detection compute device 120 may assign a default risk rating to the customer (e.g., high risk), as indicated in block 818. In block 820, the behavior detection compute device 120 determines the subsequent course of action based on whether the financial product for which the payments were made is related to a retail mortgage. If the payments are not for a retail mortgage, the test 800 advances to block 822, in which the behavior detection compute device 120 determines whether a corresponding risk threshold (which may be based on a combination of thresholds) is satisfied for a retail loan that is not related to a mortgage. In doing so, if the customer has a low or medium risk rating, the behavior detection compute device 120 determines whether the customer paid off a loan of at least $50,000 in a window of 90 days from the issuance of the loan, as indicated in block 824. If the risk rating of the customer is high, the behavior detection compute device 120 instead determines whether the customer paid off a loan of at least $50,000 in a window of 180 days from the issuance of the loan, as indicated in block 826. That is, if the customer already has a high risk as indicated in the risk rating (e.g., based on Know Your Customer (KYC) due diligence information), then the behavior detection compute device 120 applies a lower threshold for the remaining component of the test (e.g., the period of time in which the loan is paid off is longer). If the risk threshold associated with the applicable block 824, 826 is satisfied, then the behavior detection compute device 120 determines that the early payoff scenario (e.g., behavior) has been detected and that corresponding risk may be present for the financial institution 110.

Referring back to block 820, if the financial product is related to a retail mortgage, the test 800 instead branches to block 828, in which the behavior detection compute device 120 determines whether a corresponding risk threshold (which may be based on a combination of conditions) has been satisfied. Given that a mortgage is typically for a larger sum of money than other types of lending products, the behavior detection compute device 120 applies thresholds based on a larger payoff amount. That is, if the customer has a low or medium risk rating, the behavior detection compute device 120 determines whether the customer paid off a mortgage of at least $500,000 in a time period of 90 days from the issuance of the mortgage, as indicated in block 830. If, however, the customer has a high risk rating, the behavior detection compute device 120 determines whether the customer paid off a mortgage of $500,000 or more over a time period of 180 days. If the risk threshold associated with the corresponding block 830, 832 is satisfied, the behavior detection compute device 120 determines that the early payoff scenario has been detected and corresponding risk exists for the financial institution 110.

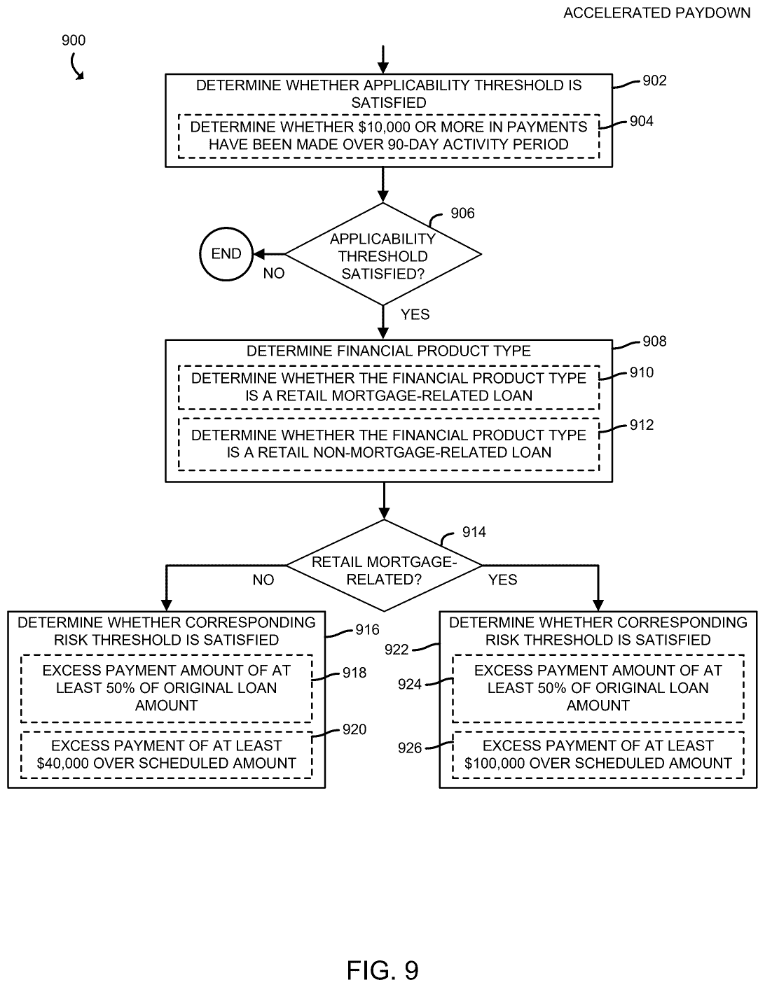

Referring back FIG. 5, the behavior detection compute device 120 may apply a test to detect an accelerated paydown scenario, as indicated in block 352. The behavior detection compute device 120 may determine whether to apply the test for accelerated paydown if the financial product involved in a given set of financial transactions under analysis is associated with the accelerated paydown test (e.g., if the financial product is a retail loan, other than a student loan, as indicated in the table 700). Referring briefly to FIG. 9, an embodiment of the test 900 to detect accelerated paydown is directed at identifying a scenario in which large and unusual payments on a loan are made outside of the contractual repayment schedule. This test 900 differs from the early payoff test 800 because the accelerated paydown test 900 monitors for payments that may not fully satisfy the outstanding balance of a loan. The concern addressed by the accelerated paydown test 900 is that significant paydowns on loans (e.g., significant when compared to the contractual repayment schedule) can be used as a method to aid in the placement, layering, and integration of illicit funds. The test 900 is directed at identifying accounts that have substantial risk because of the placement of relatively large illegitimate funds in the banking system to paydown loans and purchase assets. The test 900 is focused at the account level and, in the illustrative embodiment, has a monthly frequency, and has a one month lookback (e.g., the month in which the loan was not paid off) plus the prior 90-day activity period. That is, for a given customer, the window of time is the most recent payment transaction plus the prior 90-day activity in which at least one payment is in the last month.

In the illustrative embodiment, the behavior detection compute device 120 determines whether an applicability threshold (e.g., floor) is satisfied, as indicated in block 902. In doing so, and as indicated in block 904, the behavior detection compute device 120 may determine whether $10,000 or more in payments have been made over a 90-day activity period. The applicability threshold (e.g., $10,000), in the illustrative embodiment, applies to 90 days of account activity to provide sufficient payment activity to determine whether paydowns are accelerated. Given that timeframe, the $10,000 threshold, in the illustrative embodiment, is defined to exclude a population of accounts making accelerated paydowns within expected tolerances. In block 906, the behavior detection compute device 120 determines the subsequent course of action based on whether the applicability threshold was satisfied. If the applicability threshold was not satisfied, the test 900 ends. Otherwise, the test 900 advances to block 908 in which the behavior detection compute device 120 determines the specific financial product type involved. In doing so, the behavior detection compute device 120, in the illustrative embodiment, determines whether the financial product is a loan related to a retail mortgage, as indicated in block 910, or whether the financial product is a retail loan that is not related to a mortgage, as indicated in block 912.

In block 914, the behavior detection compute device 120 determines the subsequent course of action based on whether the financial product is related to a retail mortgage. If not, the test 900 advances to block 916, in which the behavior detection compute device 120 determines whether a corresponding risk threshold is satisfied. In doing so, in the illustrative embodiment, the behavior detection compute device 120 determines whether an excess payment amount of at least 50% of the loan amount was paid in the applicable time window, as indicated in block 918, and determines whether the excess payment was at least $40,000 over the scheduled amount, as indicated in block 920. In some embodiments, the behavior detection compute device 120 may determine that the risk threshold is satisfied only if both conditions (e.g., from blocks 918, 920) are satisfied. In other embodiments, the behavior detection compute device 120 may determine that the risk threshold has been satisfied if either of the conditions (e.g., from blocks 918, 920) is satisfied. Referring back to block 914, if the behavior detection compute device 120 instead determines that the product is related to a retail mortgage, the test 900 proceeds to block 922, in which the behavior detection compute device 120 determines whether a corresponding risk threshold (e.g., for accelerated paydown on a retail mortgage) is satisfied. In doing so, the behavior detection compute device 120 may determine whether the excess payment(s) amount to at least 50% of the original loan amount, as indicated in block 924. The behavior detection compute device 120 may also determine whether the excess payment(s) are at least $100,000 over the scheduled amount (e.g., according to the mortgage contract) to be paid over the time period, as indicated in block 926. In some embodiments, the behavior detection compute device 120 determines that the risk threshold has been satisfied when both conditions (e.g., associated with block 924, 926) are satisfied while in other embodiments, the behavior detection compute device 120 may determine that the risk threshold has been satisfied if either of the conditions (e.g., associated with blocks 924, 926) is true. If the risk threshold associated with the applicable block 916, 922 is satisfied, then the behavior detection compute device 120 determines that the accelerated paydown scenario (e.g., behavior) has been detected and that corresponding risk may be present for the financial institution 110.

The behavior detection compute device 120 may apply a test to detect an excessive credit balance refund scenario, as indicated in block 354. The test for excessive credit balance refunds monitors excessive (e.g., satisfying a threshold amount) refunds sent to borrows due to overpayment. The concern is that customers may make overpayments using dirty money (e.g., money obtained from illegal activities) and subsequently request a refund of an overpayment, thereby giving the appearance of legitimate funds. In the illustrative embodiment, the behavior detection compute device 120 may apply the test for a set of financial transactions relating to a retail term loan, a corporate credit card, a retail credit card, a retail home equity line of credit, or a retail personal line of credit, as indicated in the table 700 of FIG. 7. In other embodiments, the behavior detection compute device 120 may apply the test for excessive credit balance refunds for a different financial product that would accept overpayment and would allow issuance of a refund back to the account holder (e.g., customer). In the illustrative embodiment, the behavior detection compute device 120 is focused on the account level, has a monthly frequency, and a lookback of one month plus the prior 30-day activity period (e.g., for each focal entity (e.g., account), the 30-day activity period with the maximum total refund amount where at least one refund is in the last month).

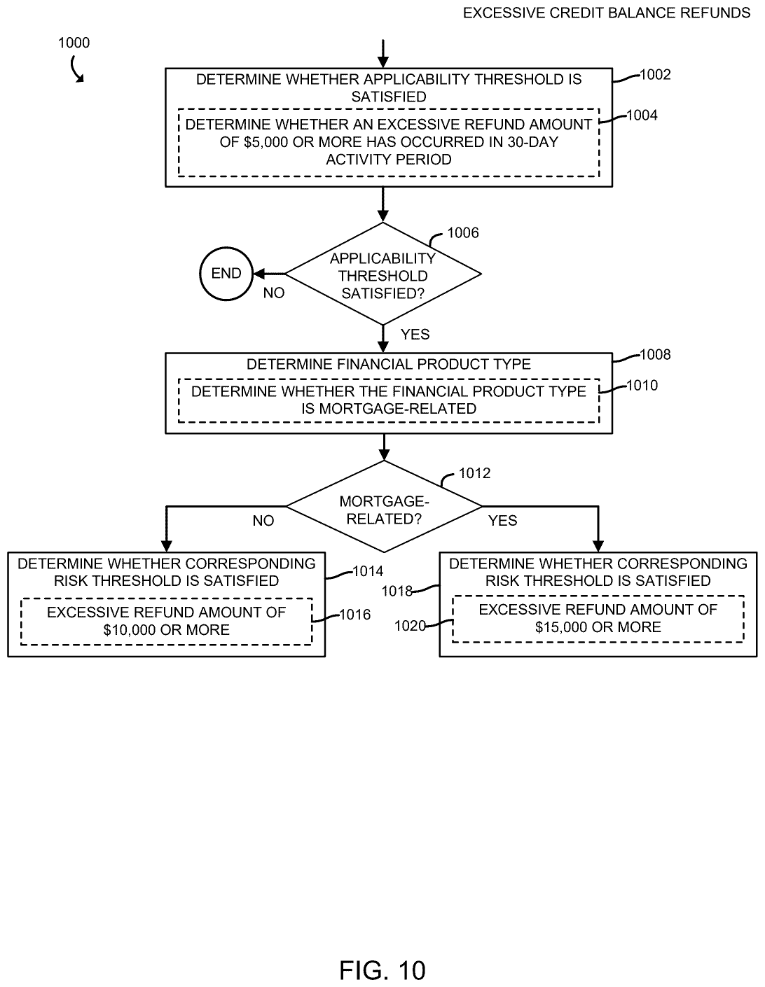

FIG. 10, in an illustrative embodiment of the test 1000 for detecting an excessive credit balance refunds scenario, the behavior detection compute device 120 initially determines whether an applicability threshold is satisfied, as indicated in block 1002. In doing so, the behavior detection compute device 120, in the illustrative embodiment, determines whether an excessive refund amount of $5,000 or more has occurred in a 30-day activity period, as indicated in block 1004. The $5,000 applicability threshold (e.g., floor) represents the lowest threshold required for a Suspicious Activity Report (SAR) filing. In block 1006, the behavior detection compute device 120 determines the subsequent course of action based on whether the applicability threshold was satisfied. If the applicability threshold was not satisfied, the behavior detection compute device 120 discontinues the test 1000. Otherwise, the test 1000 proceeds to block 1008, in which the behavior detection compute device 120 determines the specific type of financial product associated with the financial transactions. In doing so, and as indicated in block 1010, the behavior detection compute device 120 determines whether the financial product type is related to a mortgage.

In block 1012, the behavior detection compute device 120 determines the subsequent course of action based on whether the financial product type is related to a mortgage. If the financial product type is not related to a mortgage, the test 1000 advances to block 1014 in which the behavior detection compute device 120 determines whether a corresponding risk threshold is satisfied (e.g., for a financial product that is not mortgage related). In doing so, in the illustrative embodiment, the behavior detection compute device 120 determines whether an excessive refund amount of $10,000 or more occurred in the activity period, as indicated in block 1016. Referring back to block 1012, if the financial product type is related to a mortgage, then the test 1000 instead proceeds to block 1018 in which the behavior detection compute device 120 determines whether a corresponding risk threshold is satisfied. In doing so, in the illustrative embodiment, the behavior detection compute device 120 determines whether an excessive refund amount of $15,000 or more occurred in the activity period, as indicated in block 1020. If either of the risk thresholds associated with blocks 1014 and 1018 is satisfied, the behavior detection compute device 120 determines that the excessive credit balance refund scenario has been detected and that corresponding risk may exist for the financial institution 110.

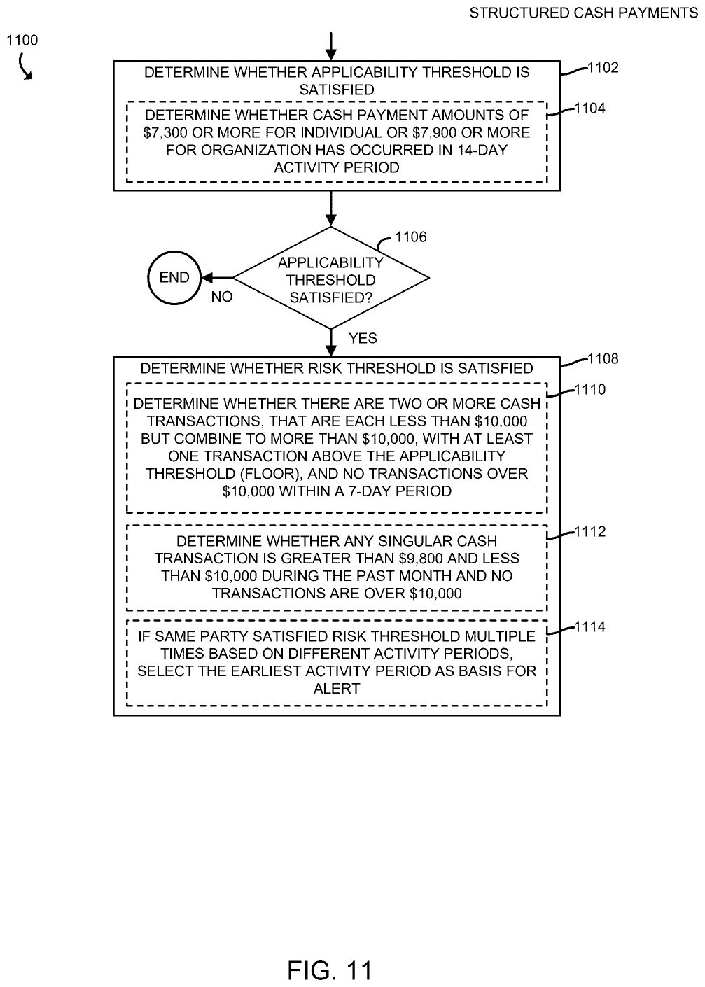

Referring back to FIG. 5, the behavior detection compute device 120 may perform a test to detect a structured cash scenario, as indicated in block 356. In the illustrative embodiment, the behavior detection compute device 120 may perform the test for a structured cash scenario if the financial product is a term loan, other than vendor finance or a student loan, or is a line of credit, other than a corporate line of credit, as indicated in the table 700 of FIG. 7. The test for a structured cash scenario is designed to monitor cash payments made to loans that are conducted in a manner to avoid a reporting requirement. More specifically, the concern is that customers may make multiple payments using dirty money (e.g., money obtained through illegal activities) to avoid the Currency Transaction Report (CTR) reporting requirement according to federal regulations. The test, in the illustrative embodiment, has a customer or account focus, a monthly frequency, and a lookback of one month (with cash transactions) plus the prior 14 days of activity. Referring now to FIG. 11, in an illustrative embodiment of the test 1100 for detecting structured cash payments, the behavior detection compute device 120 initially determines whether the financial transactions for the financial product in question, for a given customer, satisfy an applicability threshold (e.g., floor), as indicated in block 1102. In doing so, and as indicated in block 1104, the behavior detection compute device 120 determines whether cash payments amounts of $7,300 or more for an individual or $7,900 or more for an organization has occurred in a 14-day activity period.

In block 1106, the behavior detection compute device 120 determines the subsequent course of action based on whether the applicability threshold was satisfied. If it was not satisfied, the behavior detection compute device 120 ends the test. Otherwise, the test 1100 advances to block 1108 in which the behavior detection compute device 120 determines whether the corresponding risk threshold is satisfied. In doing so, the behavior detection compute device 120 may test for several conditions. As indicated in block 1110, the behavior detection compute device 120 may determine whether there are two or more transactions that are each less than $10,000 but combine to more than $10,000 with at least one transaction above the applicability threshold (floor) from block 1102, and no transactions over $10,000 within a 7-day period. The behavior detection compute device 120 may additionally or alternatively determine whether any singular cash transaction is great than $9,800 and less than $10,000 during the past month and no transactions are over $10,000, as indicated in block 1112. In the illustrative embodiment, if either condition (e.g., associated with blocks 1110, 1112) is present, the behavior detection compute device 120 determines that the structured cash payments scenario has been detected and that corresponding risk may exist for the financial institution 110. Further, as indicated in block 1114, in the illustrative embodiment, if the same party satisfied the risk threshold multiple time based on different activity period, the behavior detection compute device 120 selects the earliest activity period as the basis for an alert (e.g., as the basis for a determination the structured cash payments scenario has been detected and that corresponding risk may be present for the financial institution 110).

Referring back to FIG. 5, the behavior detection compute device 120 may apply a test to detect a significant cash payment scenario, as indicated in block 358. In the illustrative embodiment, the behavior detection compute device 120 performs the test for the significant cash payment scenario if a set of financial transactions in the financial transaction data pertain to a term loan other than vendor finance or a student loan or to a line of credit other than a corporate letter of credit, as indicated in the table 700 of FIG. 7. The test for significant cash payments is configured to monitor cash payments that appear unusual. The concern is that customers can make large dollar cash payments on loans and this can be used as a method to aid in the placement, layering, and integration of illicit funds. As such, the test for significant cash payments enables the behavior detection compute device 120 to identify customers that represent substantial risk because of the placement of large illegitimate funds into the banking system. In the illustrative embodiment, the test is focused on the customer level, has a monthly frequency, and has a lookback of one month plus the prior 30-day activity period (e.g., for each customer, the 30-day activity period with the maximum total cash amount where at least one cash transaction is in the last month).

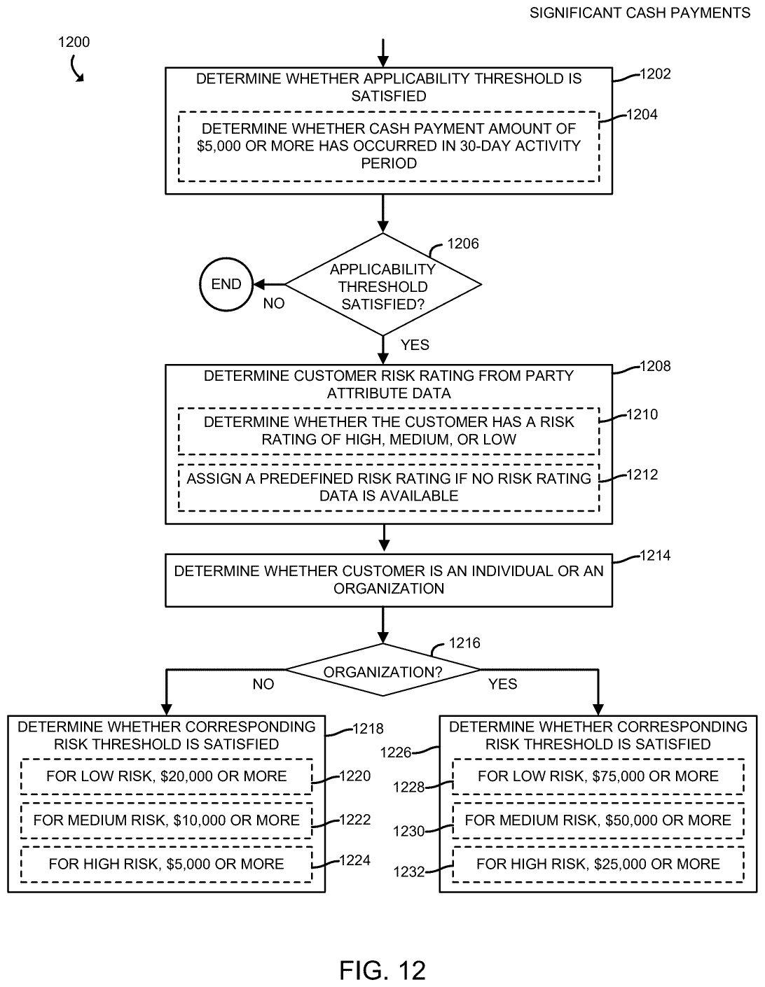

Referring now to FIG. 12, in performing the test 1200 to detect significant cash payments, the behavior detection compute device 120 initially determines whether a set of financial transactions satisfy an applicability threshold (e.g., floor), as indicated in block 1202. In doing so, the behavior detection compute device 120, in the illustrative embodiment, determines whether the financial transactions indicate that a payment amount of $5,000 or more has occurred in a 30-day activity period, as indicated in block 1204. The applicability threshold (e.g., floor) of $5,000 represents the lowest threshold required for a Suspicious Activity Report (SAR) filing according to federal regulations. In block 1206, the behavior detection compute device 120 determines whether to continue the test 1200 based on whether the applicability threshold was satisfied. If not, the behavior detection compute device 120 ends the test. Otherwise, the test 1200 continues to block 1208, in which the behavior detection compute device 120 determines the customer risk rating from the party attribute data. In doing so, and as indicated in block 1210, the behavior detection compute device 120 may determine whether the customer has a risk rating of high, medium, or low. In instances in which no risk rating is available for the customer in the party attribute data, the behavior detection compute device 120 may assign a predefined risk rating (e.g., high) to the customer, as indicated in block 1212.

In block 1214, the behavior detection compute device 120 determines whether the customer associated with the set of financial transactions under scrutiny is an individual or an organization (e.g., based on whether the corresponding financial product is a retail product or a corporate product, based on the party attribute data, and/or based on other data sources). In block 1216, the behavior detection compute device 120 determines the subsequent course of action based on whether the customer is an organization or not. If the customer is not an organization, the test 1200 proceeds to block 1218, in which the behavior detection compute device determines whether a corresponding risk threshold is satisfied. In doing so, the behavior detection compute device 120 tests for conditions that vary as a function of the customer risk rating. That is, if the customer has a low risk rating, the behavior detection compute device 120 may determine whether the cash payments amount to $20,000 or more over the activity period, as indicated in block 1220. If the customer has a medium risk rating, the behavior detection compute device 120 may determine whether the cash payments amount to $10,000 or more, as indicated in block 1222. Alternatively, if the customer has a high risk rating, the behavior detection compute device 120 may determine whether the cash payments amount to $5,000 or more, as indicated in block 1224.

Referring back to block 1216, if the customer is an organization, the test 1200 advances to block 1226 in which the behavior detection compute device 120 determines whether a corresponding risk threshold (e.g., for cash payments made by an organization) is satisfied. In doing so, the behavior detection compute device 120 tests for larger sums of cash than if the customer is an individual. As indicated in block 1228, if the customer has a low risk rating, the behavior detection compute device 120 may determine whether the cash payments amount to $75,000. If the customer has a medium risk score, the behavior detection compute device 120 may determine whether the cash payments amount to $50,000, as indicated in block 1230. Alternatively, if the customer has a high risk score, the behavior detection compute device 120 may determine whether the cash payments amount to $25,000 or more, as indicated in block 1232. If the applicable conditions for a corresponding risk threshold are satisfied, the behavior detection compute device 120, in the illustrative embodiment, determines that the significant cash payments scenario has been detected and that corresponding risk may exist for the financial institution 110.

Referring back to FIG. 5, the behavior detection compute device 120 may apply a test to detect a multiple loan scenario, as indicated in block 360. The behavior detection compute device 120 may apply the test if the financial product associated with a set of financial transactions is a term loan other than vendor finance or a student loan. In applying the test, the behavior detection compute device 120 monitors for excessive (e.g., satisfying a corresponding threshold) opening and closing of term loan accounts that are not reasonable (e.g., according to a defined threshold) for the customer. The concern addressed by the test is that customers might open and close multiple term loan accounts frequently in a relatively short period of time and might use illegitimate funds to close those loan accounts. In the illustrative embodiment, the test has a customer focus and a monthly frequency. Further, in the illustrative embodiment, the test has a lookback period of one month plus the prior 365-day activity period.

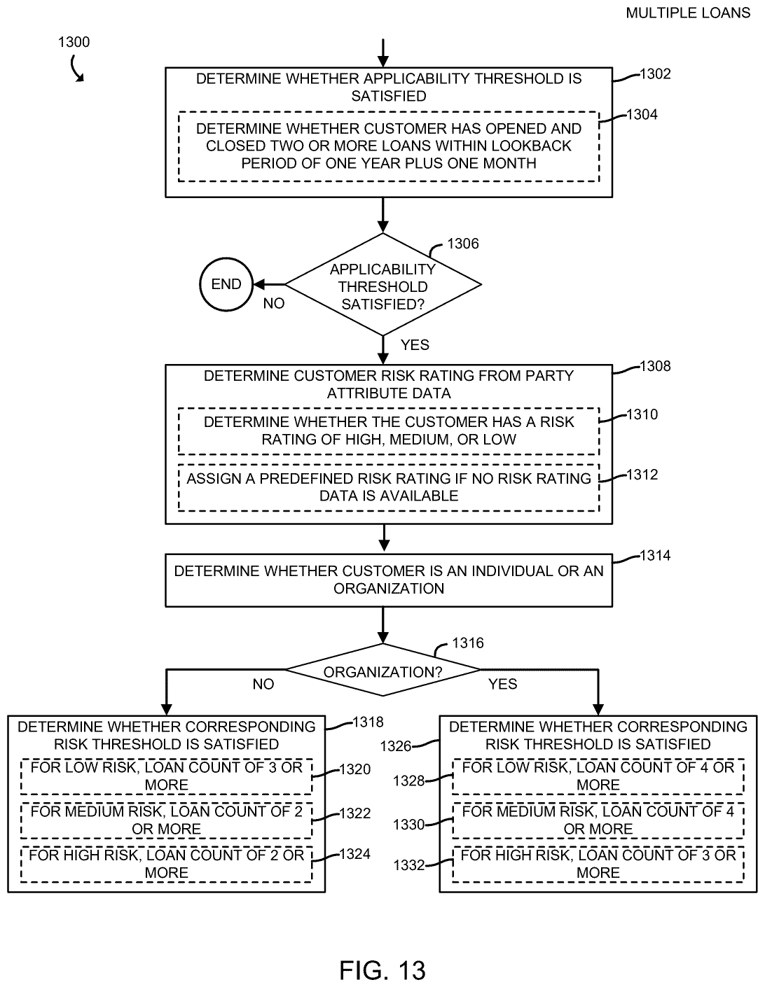

Referring now to FIG. 13, in applying the test 1300, the behavior detection compute device 120, in the illustrative embodiment, determines whether an applicability threshold (e.g., floor) is satisfied, as indicated in block 1302. In doing so, and as indicated in block 1304, the behavior detection compute device 120 may determine whether the customer has opened and closed two or more loans within a lookback period of one year plus one month. In block 1306, the behavior detection compute device 120 determines the subsequent course of action based on whether the applicability threshold (e.g., floor) was satisfied. If the applicability threshold was not satisfied, the behavior detection compute device 120 ends the test 1300. Otherwise, the test 1300 advances to block 1308 in which the behavior detection compute device 120 determines the customer risk rating from the party attribute data. In doing so, the behavior detection compute device 120 may determine whether the customer has a risk rating of high, medium, or low, as indicated in block 1310. In instances in which no risk rating is available for a customer, the behavior detection compute device 120 may assigne a predefined risk rating (e.g., high risk) to the customer, as indicated in block 1312.

In block 1314, the behavior detection compute device 120 determines whether the customer is an individual or an organization (e.g., based on whether the corresponding financial product is a retail financial product or a corporate financial product, based on the party attribute data, and/or other sources). Further, in block 1316, the behavior detection compute device 120 determines the subsequent course of action based on whether the customer is an organization or not. If the customer is not an organization (e.g., the customer is an individual), the test 1300 advances to block 1318, in which the behavior detection compute device 120 determines whether a corresponding risk threshold is satisfied. In doing so, the behavior detection compute device 120 selects condition to test for as a function of the risk rating of the customer. More specifically, in the illustrative embodiment, if the risk rating of the customer is low, the behavior detection compute device 120 determines whether three or more loans have been opened and closed during the activity period, as indicated in block 1320. If, however, the customer risk rating is medium or high, the behavior detection compute device 120, in the illustrative embodiment, determines whether two or more loans have been opened and closed during the activity period, as indicated in blocks 1322 and 1324.

Referring back to block 1316, if the customer is an organization, the test 1300 instead advances to block 1326, in which the behavior detection compute device 120 determines whether a corresponding risk threshold is satisfied. In doing so, if the customer risk rating is low or medium, the behavior detection compute device 120 may determine whether four or more loans have been opened and closed during the activity period, as indicated in blocks 1328 and 1330. Otherwise, if the customer risk rating is high, the behavior detection compute device 120 may determine whether the customer has opened and closed three or more loans within the activity period, as indicated in block 1332. In response to a determination that the corresponding risk threshold has been satisfied, the behavior detection compute device 120 determines that the multiple loans scenario has been detected and that corresponding risk may exist for the financial institution 110.

In the illustrative embodiment, the behavior detection compute device 120 may apply a test to detect a scenario in which the customer has made one or more credit card purchases at one or more merchants satisfying a defined risk level, as indicated in block 362 of FIG. 5. The behavior detection compute device 120 may apply the test if the set of financial transactions in question pertain to a business credit card, a corporate line of credit card, a retail consumer card, or a retail line of credit card, as indicated in the table 700 of FIG. 7. The test enables the behavior detection compute device 120 to monitor for purchases at merchants designated as representing a sufficiently high risk (e.g., as indicated in a database 140, 142), based, for example, on the type of business operations or line of business that each merchant is in (e.g., based on a code (e.g., a merchant category code (MCC) indicative of the line of business). Those merchants may be, for example, casinos or pawn shops. The test, in the illustrative embodiment, is focused at the account level and has a monthly frequency. Further, in the illustrative embodiment, the test has a lookback period of one month plus the prior 30-day activity period (e.g., for each account, the 30-day activity period with the maximum total purchase amount, where at least one sufficiently high risk merchant transaction is in the last month).

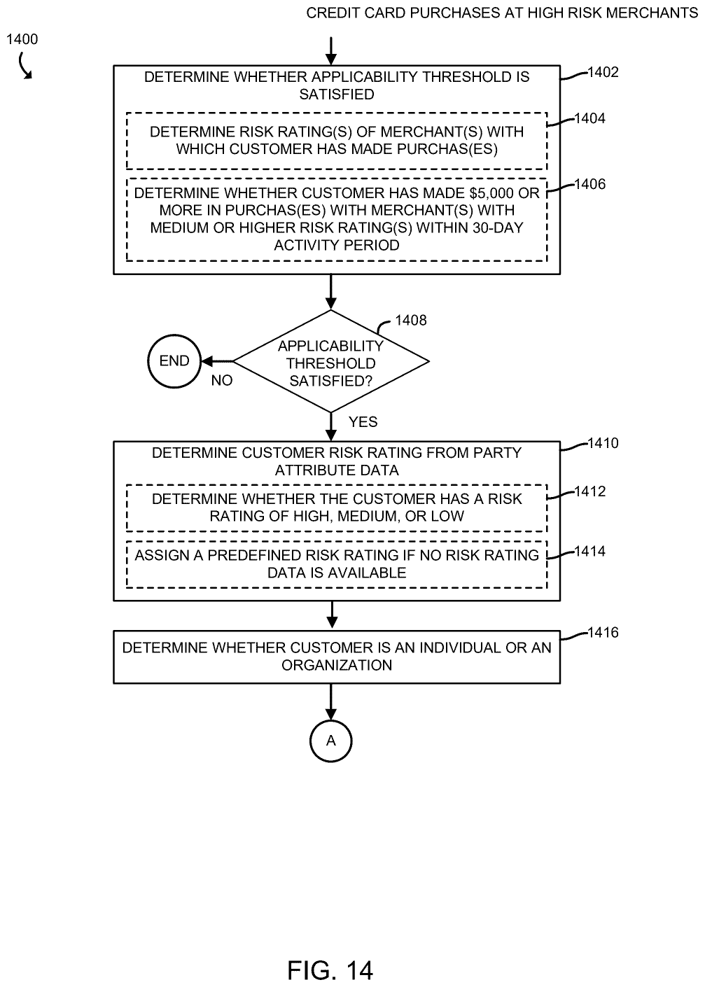

Referring now to FIG. 14, the behavior detection compute device 120, in the illustrative embodiment, initially determines whether an applicability threshold is satisfied by a set of financial transactions in question, as indicated in block 1402. In doing so, and as indicated in block 1404, the behavior detection compute device 120 determines the risk ratings of merchants with which the customer has made purchases, as indicated in block 1404. As referred to above, the risk ratings for merchants may be indicated in a database 140, 142. For merchants having a merchant category code (MCC) of 7995 or 7801, indicative of internet gaming, sweepstakes cafes, and gaming centers, 5051, indicative of scrap metal dealers, or 8398, indicative of charities and non-governmental organizations, the risk rating may be medium. For merchants with an MCC of 5094 or 5944, indicative of jewelry, 5933, indicative of pawnshops, or 9223, indicative of bail and bond payments, the risk rating may be high. Further, for merchants with an MCC of 4829, indicative of money services businesses, or 6051, indicative of a virtual currency exchange or administrator, the risk rating may be very high. In block 1406, the behavior detection compute device 120 may determine whether the customer has made $5,000 or more in purchases with one or more merchants with a medium or higher risk rating within a 30-day activity period. In the illustrative embodiment, if the conditions above are satisfied, then the behavior detection compute device 120 determines that applicability threshold for that set of financial transactions is satisfied. In block 1408, the behavior detection compute device 120 determines the subsequent course of action based on whether the applicability threshold (e.g., of block 1402) is satisfied.

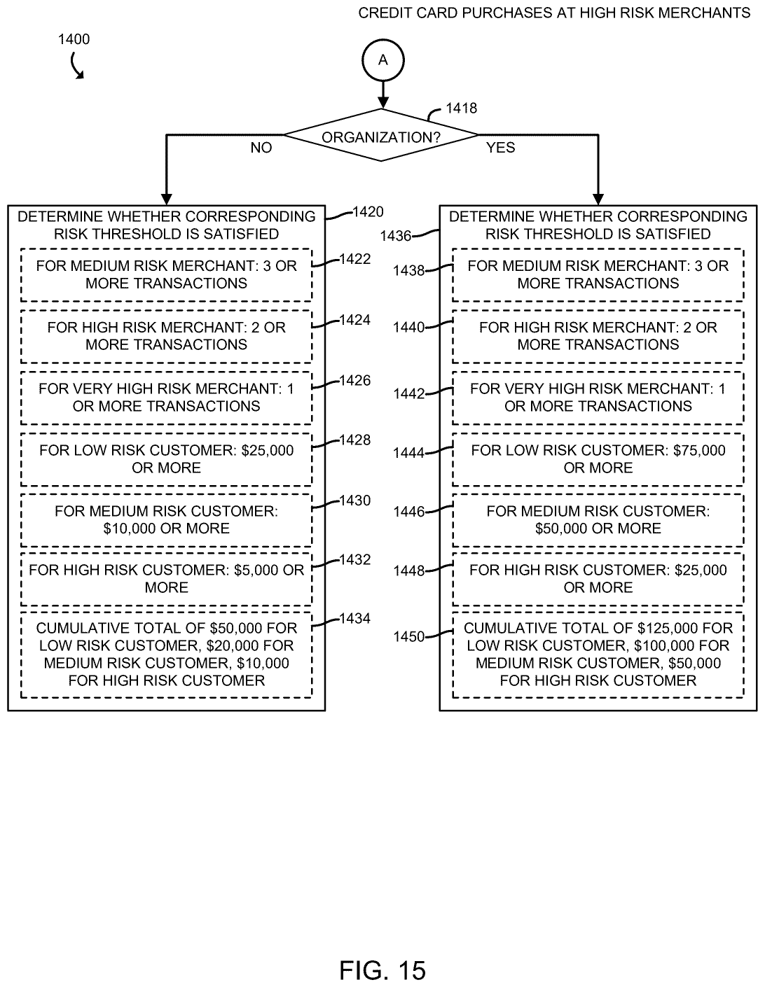

If the applicability threshold is not satisfied, the test 1400 ends. Otherwise, the test 1400 advances to block 1410, in which the behavior detection compute device 120 determines the customer risk rating from the party attribute data. In doing so, and as indicated in block 1412, the behavior detection compute device 120 may determine whether the customer has a risk rating of high, medium, or low. If a risk rating is not available for the customer, the behavior detection compute device 120 may assign a predefined risk rating (e.g., high) to the customer, as indicated in block 1414. In block 1416, the behavior detection compute device 120 determines whether the customer is an individual or an organization (e.g., based on the financial product, the party attribute data, and/or other sources). The test 1400, in the illustrative embodiment, proceeds to block 1418 of FIG. 15, in which the behavior detection compute device 120 determines the subsequent course of action based on whether the customer is an organization or not.

Referring now to FIG. 15, if the customer is not an organization, the behavior detection compute device 120 determines whether a corresponding risk threshold is satisfied in block 1420. In doing so, the behavior detection compute device 120 may select from several conditions to test for, based on the risk rating of the merchant and the risk rating of the customer. If the merchant is medium risk, the behavior detection compute device 120 may determine whether the customer made three or more financial transactions with the merchant during the activity period, as indicated in block 1422. If the merchant is high risk, the behavior detection compute device 120 may determine whether two or more financial transactions were made in the activity period, as indicated in block 1424. However, if the merchant is very high risk, the behavior detection compute device 120 may determine whether one or more financial transaction were made in the activity period, as indicated in block 1426.

Focusing on the risk rating of the customer, the behavior detection compute device 120 may determine whether the customer made one or more purchases of $25,000 or more in the activity period if the customer has a low risk rating. If the customer has a medium risk rating, the behavior detection compute device 120 may determine whether the customer made purchases of $10,000 or more, as indicated in block 1430. However, if the customer has a high risk rating, the behavior detection compute device 120 may determine whether the customer made purchases of $5,000 or more, as indicated in block 1432. The behavior detection compute device 120 may also test for a cumulative total in purchases across merchants of varying risk ratings. In doing so, and as indicated in block 1434, for a customer with a low risk rating, the behavior detection compute device 120 may determine whether the purchases during the activity period total to $50,000 or more. For a customer with a medium risk rating, the behavior detection compute device 120 may determine whether the purchases amount to $20,000 or more, and for a customer with a high risk rating, the behavior detection compute device 120 may determine whether the purchases total to $10,000 or more.

Referring back to block 1418, if the customer is an organization, the behavior detection compute device 120 determines whether a corresponding risk threshold is satisfied in block 1436. In doing so, the behavior detection compute device 120 may determine whether the customer made three or more transactions with a medium risk merchant, two or more transactions with a high risk merchant, and/or one or more transactions with a very high risk merchant, as indicated in blocks 1438, 1440, and 1442. For low risk customers (e.g., having a risk rating of low), the behavior detection compute device 120 may determine whether the customer made one or more transactions of $75,000 or more during the activity period, as indicated in block 1444. For a customer having a medium risk rating, the behavior detection compute device 120 may determine whether the customer made one more transactions of $50,000 or more during the activity period, as indicated in block 1446. The behavior detection compute device 120 may determine, for a high risk customer (e.g., having a risk rating of high), whether the customer made one or more financial transactions of $25,000 or more during the activity period, as indicated in block 1448. In block 1450, the behavior detection compute device 120 may determine whether the customer had a cumulative total of $125,000 or more in transactions if the customer has a low risk rating, $100,000 or more in transactions if the customer has a medium risk rating, or $50,000 or more if the customer has a high risk rating. In response to a determination that the applicable conditions are true, the behavior detection compute device 120 determines that the corresponding risk threshold is satisfied. If the corresponding risk threshold is satisfied (e.g., from block 1420 or block 1436), the behavior detection compute device 120 may determine that the credit card purchases at sufficiently high risk merchants scenario is present and that corresponding risk may exist for the financial institution 110.

Referring back to FIG. 5, the behavior detection compute device 120 may apply a test to detect a scenario in which a customer has obtained one or more cash advances from one or more countries deemed high risk, as indicated in block 364. The behavior detection compute device 120 may apply the test if the set of financial transactions under analysis pertain to a business credit card, a corporate line of credit card, a retail consumer card, or a retail line of credit card, as indicated in the table 700 of FIG. 7. In performing the test, the behavior detection compute device 120 monitors for cash advances that occur in jurisdictions that have been designated (e.g., as indicated by data in a database 140, 142) as high risk or very high risk. The concern is that customers may conduct activity from a higher-risk geographic location without an apparent business reason and inconsistent with the customer's history. In the illustrative embodiment, the test is focused on the account level and has a monthly frequency. Further, the test in the illustrative embodiment has a lookback period of one month plus the prior 30-day activity period (e.g., for each account, the 30-day activity period with the maximum comprehensively sanctioned risk (CSR) country total cash advance amount if there existed at least one CSR cash advance transaction). Otherwise, the period is based on the maximum high risk country total cash advance amount, where at least one high risk or CSR country cash advance is in the last month.

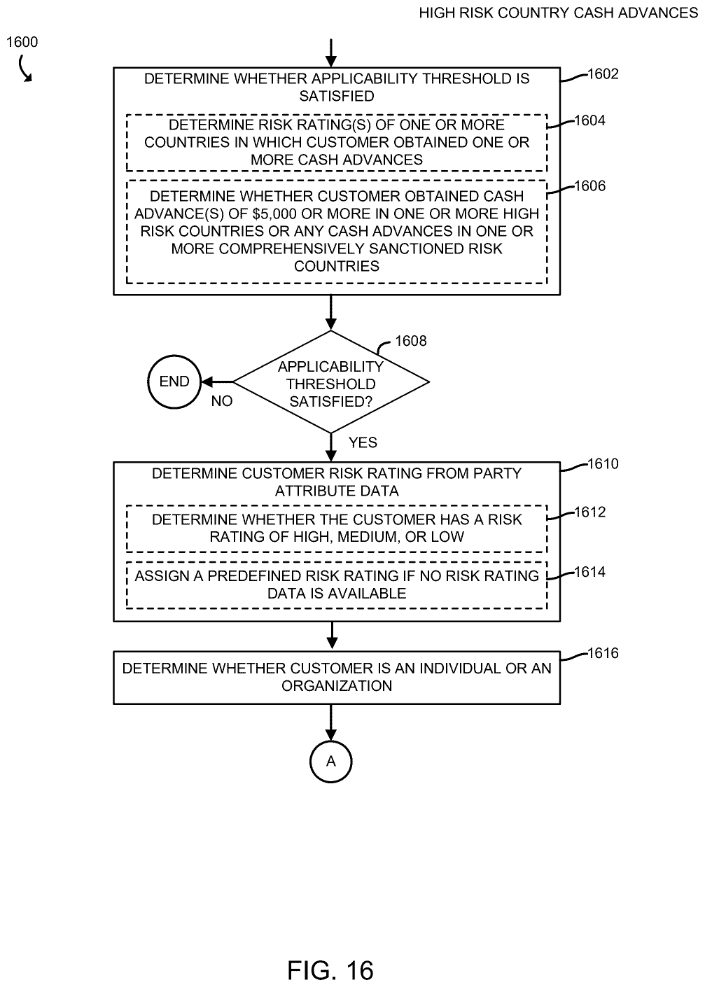

Referring now to FIG. 16, in applying the test 1600 for detecting the high risk country cash advances scenario, the behavior detection compute device 120 may determine whether the set of financial transactions in question satisfy an applicability threshold, as indicated in block 1602. In doing the, the behavior detection compute device 120 may determine the risk rating of one or more countries (e.g., as indicated by data in a database 140, 142) in which the customer obtained one or more cash advances, as indicated in block 1604. The behavior detection compute device 120 may also determine whether the customer obtained one or more cash advances of $5,000 (e.g., the threshold for a Suspicious Activity Report (SAR) according to federal regulations) or more in one or more high risk countries or any cash advances in one or more comprehensively sanctioned risk (CSR) countries, as indicated in block 1606.

In block 1608, the behavior detection compute device 120 determines the subsequent course of action based on whether the applicability threshold (e.g., from block 1602) is satisfied. If the applicability threshold is not satisfied, in the illustrative embodiment, the test 1600 ends. Otherwise (e.g., if the applicability threshold is satisfied), the test 1600 advances to block 1610 in which the behavior detection compute device 120 determines the customer risk rating from the party attribute data. In doing so, and as indicated in block 1612, the behavior detection compute device 120 may determine whether the customer has a risk rating of high, medium, or low. In some embodiments, if a risk rating for the customer is not present, the behavior detection compute device 120 may assign a predefined risk rating (e.g., high risk) to the customer, as indicated in block 1614. In block 1616, the behavior detection compute device 120 determines whether the customer is an individual or an organization (e.g., based on the financial product, party attribute data, and/or other sources).

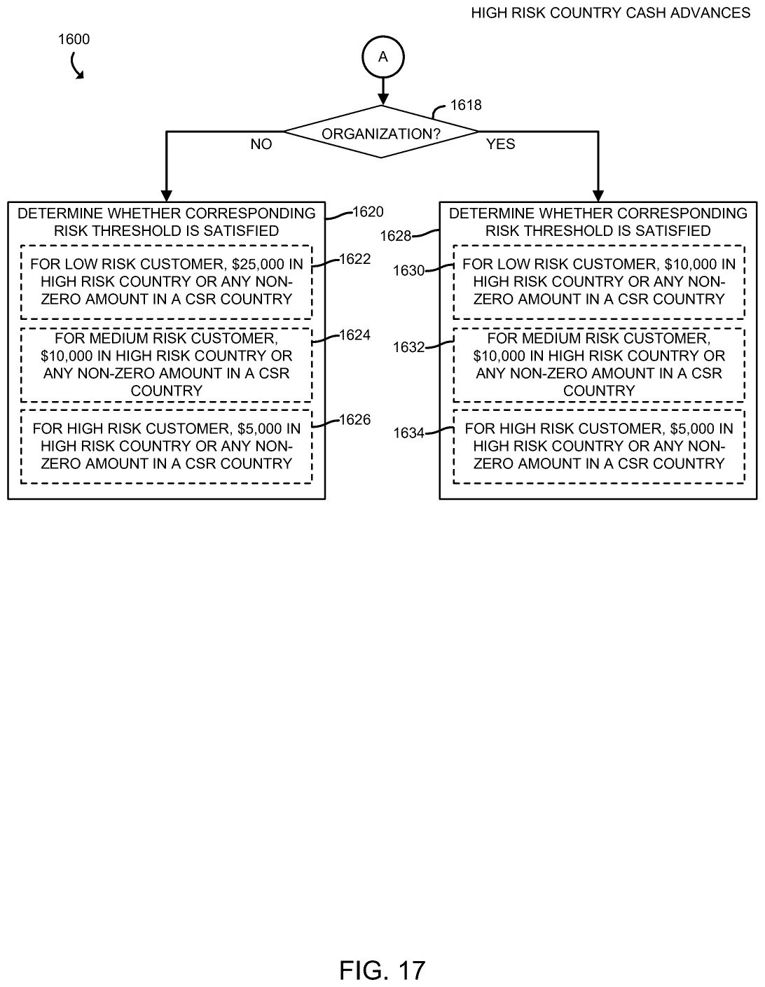

Continuing the test 1600 and referring to FIG. 17, the behavior detection compute device 120 determines the subsequent course of action based on whether the customer is an organization or not, in block 1618. If the customer is not an organization (e.g., the customer is an individual), the test 1600 advances to block 1620 in which the behavior detection compute device 120 determines whether the set of financial transactions under analysis satisfy a corresponding risk threshold. In doing so, the behavior detection compute device 120 may determine, for a low risk customer, whether the customer had one or more cash advances of $25,000 or more in a high risk country or any non-zero amount in a CSR (comprehensively sanctioned risk) country, as indicated in block 1622. For a medium risk customer, the behavior detection compute device 120 may determine whether the customer had one or more cash advances of $10,000 or more in a high risk country or any non-zero amount in a CSR country, as indicated in block 1624. If the customer has a high risk rating, the behavior detection compute device 120 may determine whether the customer had $5,000 or more in cash advances in a high risk country or any non-zero amount in a CSR country, as indicated in block 1626.

Referring back to block 1618, if the customer is an organization, the test 1600 instead advances to block 1628 in which the behavior detection compute device 120 determines whether a corresponding risk threshold (e.g., for an organization as the customer) is satisfied. In doing so, and as indicated in block 1630, the behavior detection compute device 120 may determine whether the customer had $10,000 or more in cash advances in a high risk country or any non-zero amount of cash advances in a CSR country, if the customer is low risk (e.g., has a low risk rating). If the customer has a medium risk rating, the behavior detection compute device 120 may determine whether the customer had $10,000 or more in cash advances in a high risk country or any non-zero amount in a CSR country, as indicated in block 1632. In the illustrative embodiment, if the customer has a high risk rating, the behavior detection compute device 120 determines whether the customer had $5,000 or more in cash advances in a high risk country or any non-zero amount in cash advances in a CSR country, as indicated in block 1634. If the corresponding risk threshold is satisfied (e.g., from block 1620 or block 1628, depending on whether the customer is an organization or not), the behavior detection compute device 120 may determine that the high risk country cash advances scenario has been detected and that corresponding risk may exist for the financial institution 110.

In block 366, the behavior detection compute device 120 determines whether risk exposure has been detected (e.g., whether any of the scenarios associated with blocks 350, 352, 354, 356, 358, 360, 362, 364 were detected). If not, the method 300 loops back to block 302 of FIG. 3, in which the behavior detection compute device 120 continues to obtain financial transaction data. Otherwise, if the behavior detection compute device 120 did detect risk exposure, the method 300 advances to block 368, in which the behavior detection compute device 120 generates one or more alerts indicative of the detected risk exposure. The alert may be embodied as an email, a text message, an alert in a user interface (e.g., in a web-based user interface accessible using one of the user compute devices 150, 152, etc.), and/or may take another form. In providing an alert, the behavior detection compute device 120 may provide (e.g., for review by a human user) the underlying financial transaction data (e.g., that satisfied a corresponding threshold associated with one of the tests), as indicated in block 370. The behavior detection compute device 120 may also provide the underlying party attribute data (e.g., indicating the risk rating of the customer or party with whom the customer transacted), as indicated in block 372. Further, the behavior detection compute device 120 may provide data indicative of the rational for generating the one or more alerts, as indicated in block 374. For example, the behavior detection compute device 120 may indicate which risk threshold was satisfied and why (e.g., what conditions were determined to be present).

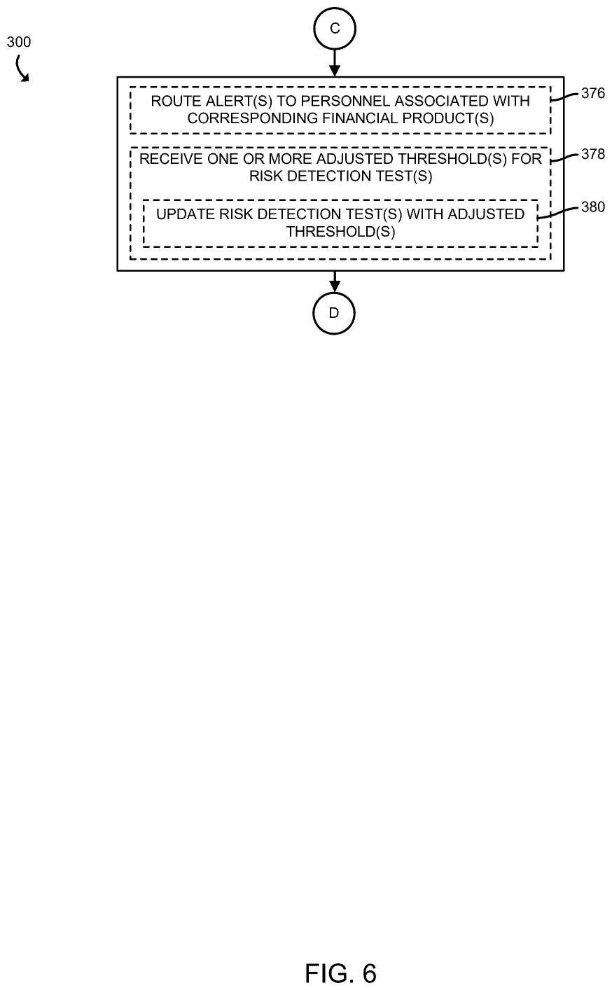

Referring now to FIG. 6, the behavior detection compute device 120 may route the alert to personnel associated with the corresponding financial product to which the alert pertains, as indicated in block 376. That is, the behavior detection compute device 120 may determine (e.g., from a database 140, 142) an identifier of a person assigned to review alerts and the underlying data (e.g., financial transaction data, party attribute data, rationale data, etc.) for a given financial product and send the alert to that person (e.g., to a queue of alerts associated with that person's identifier, to an email address, phone number, or other contact data associated with the person, etc.). In some embodiments, as indicated in block 378, the behavior detection compute device 120 may receive one or more adjusted thresholds for one or more the risk detection tests (e.g., tests associated with blocks 350, 352, 354, 356, 358, 360, 362, 364 to detect corresponding scenarios). That is, upon reviewing the underlying data associated with an alert, personnel may determine that the behavior detection compute device 120 could more accurately detect the corresponding scenario if one or more of the thresholds was adjusted, and may provide the adjusted threshold(s) to the behavior detection compute device 120 (e.g., through a corresponding user interface). In block 380, the behavior detection compute device 120 may update one or more risk detection tests with the one or more adjusted thresholds (e.g., for use in subsequent iterations of the method 300). While the operations of the method 300 are described in a particular sequence, it should be understood that in other embodiments, operations may be performed in a different order and/or in parallel (e.g., obtaining additional financial transaction data while applying scenario detection tests to already-obtained financial transaction data).

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain financial transaction data indicative of financial transactions associated with one or more lending financial products of a financial institution; apply, as a function of a corresponding lending financial product associated with the financial transactions, one or more tests to the obtained financial transaction data to detect risk exposure; and generate, in response to a determination that risk exposure has been detected, an alert to enable a human reviewer to evaluate the corresponding financial transaction data.

Example 2 includes the subject matter of Example 1, and wherein to obtain financial transaction data comprises to obtain financial transaction data for a corporate loan or a retail loan.

Example 3 includes the subject matter of any of Examples 1 and 2, and wherein to obtain financial transaction data for a corporate loan comprises to obtain financial transaction data for a commercial loan, an equipment loan, or vendor finance.

Example 4 includes the subject matter of any of Examples 1-3, and wherein to obtain financial transaction data for a retail loan comprises to obtain financial transaction data for an automobile loan, a business loan, a personal loan, a home equity loan, a mortgage loan, a construction loan, or a student loan.

Example 5 includes the subject matter of any of Examples 1-4, and wherein to obtain financial transaction data comprises to obtain financial transaction data for a corporate line of credit or a retail line of credit.

Example 6 includes the subject matter of any of Examples 1-5, and wherein to obtain financial transaction data for a corporate line of credit comprises to obtain financial transaction data for a business credit card, a line of credit card, a commercial credit line, asset based lending, or a letter of credit.

Example 7 includes the subject matter of any of Examples 1-6, and wherein to obtain financial transaction data for a retail line of credit comprises to obtain financial transaction data for a consumer credit card, a line of credit card, a business line of credit, a home equity line of credit, or a personal line of credit.

Example 8 includes the subject matter of any of Examples 1-7, and wherein the circuity is further configured to obtain party attribute data indicative of one or more attributes of at least one party to the financial transactions and wherein to apply one or more tests to the obtained financial transactions data comprises to apply the one or more tests additionally to the party attribute data to detect risk exposure.

Example 9 includes the subject matter of any of Examples 1-8, and wherein to apply, as a function of a corresponding lending financial product, one or more tests comprises to apply one or more tests with at least one risk threshold defined as a function of the corresponding financial product.

Example 10 includes the subject matter of any of Examples 1-9, and wherein to apply, as a function of a corresponding lending financial product, one or more tests comprises to apply one or more tests with at least one risk threshold defined as a function of an attribute of a party to one or more of the corresponding financial transactions.

Example 11 includes the subject matter of any of Examples 1-10, and wherein to apply one or more tests with at least one risk threshold defined as a function of an attribute of a party comprises to apply one or more tests with at least one risk threshold defined as a function of a risk rating associated with a customer.

Example 12 includes the subject matter of any of Examples 1-11, and wherein to apply one or more tests with at least one risk threshold defined as a function of an attribute of a party comprises to apply one or more tests with at least one risk threshold defined as a function of whether the party is an organization or an individual.

Example 13 includes the subject matter of any of Examples 1-12, and wherein to apply one or more tests with at least one risk threshold defined as a function of an attribute of a party comprises to apply one or more tests with at least one risk threshold defined as a function of a geographic location of the party.

Example 14 includes the subject matter of any of Examples 1-13, and wherein the party is a merchant and wherein to apply one or more tests with at least one risk threshold defined as a function of an attribute of the party comprises to apply one or more tests with at least one risk threshold defined as a function of a category of business operations of the merchant.

Example 15 includes the subject matter of any of Examples 1-14, and wherein to apply one or more tests comprises to apply a test with one or more thresholds indicative of an early payoff scenario for the corresponding lending financial product.

Example 16 includes the subject matter of any of Examples 1-15, and wherein to apply one or more tests comprises to apply a test with one or more thresholds indicative of an accelerated paydown scenario for the corresponding lending financial product.

Example 17 includes the subject matter of any of Examples 1-16, and wherein to apply one or more tests comprises to apply a test with one or more thresholds indicative of an excessive credit balance refund scenario for the corresponding lending financial product.

Example 18 includes the subject matter of any of Examples 1-17, and wherein to apply one or more tests comprises to apply a test with one or more thresholds indicative of a structured cash scenario for the corresponding lending financial product.

Example 19 includes the subject matter of any of Examples 1-18, and wherein to apply one or more tests comprises to apply a test with one or more thresholds indicative of a significant cash payment scenario for the corresponding lending financial product.

Example 20 includes the subject matter of any of Examples 1-19, and wherein to apply one or more tests comprises to apply a test with one or more thresholds indicative of a multiple loan scenario for the corresponding lending financial product.

Example 21 includes the subject matter of any of Examples 1-20, and wherein to apply one or more tests comprises to apply a test with one or more thresholds indicative of a credit card purchases at high risk merchants scenario for the corresponding lending financial product.

Example 22 includes the subject matter of any of Examples 1-21, and wherein to apply one or more tests comprises to apply a test with one or more thresholds indicative of a high risk country cash advance scenario for the corresponding lending financial product.

Example 23 includes the subject matter of any of Examples 1-22, and wherein the circuitry is further configured to obtain an adjusted threshold for at least one of the tests; and update the at least one of the tests with the adjusted threshold.

Example 24 includes a method comprising obtaining, by a compute device, financial transaction data indicative of financial transactions associated with one or more lending financial products of a financial institution; applying, by the compute device and as a function of a corresponding lending financial product associated with the financial transactions, one or more tests to the obtained financial transaction data to detect risk exposure; and generating, by the compute device and in response to a determination that risk exposure has been detected, an alert to enable a human reviewer to evaluate the corresponding financial transaction data.

Example 25 includes the subject matter of Example 24, and wherein obtaining financial transaction data comprises obtaining financial transaction data for a corporate loan or a retail loan.

Example 26 includes the subject matter of any of Examples 24 and 25, and wherein obtaining financial transaction data for a corporate loan comprises obtaining financial transaction data for a commercial loan, an equipment loan, or vendor finance.

Example 27 includes the subject matter of any of Examples 24-26, and wherein obtaining financial transaction data for a retail loan comprises obtaining financial transaction data for an automobile loan, a business loan, a personal loan, a home equity loan, a mortgage loan, a construction loan, or a student loan.

Example 28 includes the subject matter of any of Examples 24-27, and wherein obtaining financial transaction data comprises obtaining financial transaction data for a corporate line of credit or a retail line of credit.

Example 29 includes the subject matter of any of Examples 24-28, and wherein obtaining financial transaction data for a corporate line of credit comprises obtaining financial transaction data for a business credit card, a line of credit card, a commercial credit line, asset based lending, or a letter of credit.

Example 30 includes the subject matter of any of Examples 24-29, and wherein obtaining financial transaction data for a retail line of credit comprises obtaining financial transaction data for a consumer credit card, a line of credit card, a business line of credit, a home equity line of credit, or a personal line of credit.

Example 31 includes the subject matter of any of Examples 24-30, and further including obtaining, by the compute device, party attribute data indicative of one or more attributes of at least one party to the financial transactions and wherein applying one or more tests to the obtained financial transactions data comprises applying the one or more tests additionally to the party attribute data to detect risk exposure.

Example 32 includes the subject matter of any of Examples 24-31, and wherein applying, as a function of a corresponding lending financial product, one or more tests comprises applying one or more tests with at least one risk threshold defined as a function of the corresponding financial product.

Example 33 includes the subject matter of any of Examples 24-32, and wherein applying, as a function of a corresponding lending financial product, one or more tests comprises applying one or more tests with at least one risk threshold defined as a function of an attribute of a party to one or more of the corresponding financial transactions.

Example 34 includes the subject matter of any of Examples 24-33, and wherein applying one or more tests with at least one risk threshold defined as a function of an attribute of a party comprises applying one or more tests with at least one risk threshold defined as a function of a risk rating associated with a customer.

Example 35 includes the subject matter of any of Examples 24-34, and wherein applying one or more tests with at least one risk threshold defined as a function of an attribute of a party comprises applying one or more tests with at least one risk threshold defined as a function of whether the party is an organization or an individual.

Example 36 includes the subject matter of any of Examples 24-35, and wherein applying one or more tests with at least one risk threshold defined as a function of an attribute of a party comprises applying one or more tests with at least one risk threshold defined as a function of a geographic location of the party.

Example 37 includes the subject matter of any of Examples 24-36, and wherein the party is a merchant and wherein applying one or more tests with at least one risk threshold defined as a function of an attribute of the party comprises applying one or more tests with at least one risk threshold defined as a function of a category of business operations of the merchant.

Example 38 includes the subject matter of any of Examples 24-37, and wherein applying one or more tests comprises applying a test with one or more thresholds indicative of an early payoff scenario for the corresponding lending financial product.

Example 39 includes the subject matter of any of Examples 24-38, and wherein applying one or more tests comprises applying a test with one or more thresholds indicative of an accelerated paydown scenario for the corresponding lending financial product.

Example 40 includes the subject matter of any of Examples 24-39, and wherein applying one or more tests comprises applying a test with one or more thresholds indicative of an excessive credit balance refund scenario for the corresponding lending financial product.

Example 41 includes the subject matter of any of Examples 24-40, and wherein applying one or more tests comprises applying a test with one or more thresholds indicative of a structured cash scenario for the corresponding lending financial product.

Example 42 includes the subject matter of any of Examples 24-41, and wherein applying one or more tests comprises applying a test with one or more thresholds indicative of a significant cash payment scenario for the corresponding lending financial product.

Example 43 includes the subject matter of any of Examples 24-42, and wherein applying one or more tests comprises applying a test with one or more thresholds indicative of a multiple loan scenario for the corresponding lending financial product.

Example 44 includes the subject matter of any of Examples 24-43, and wherein applying one or more tests comprises applying a test with one or more thresholds indicative of a credit card purchases at high risk merchants scenario for the corresponding lending financial product.

Example 45 includes the subject matter of any of Examples 24-44, and wherein applying one or more tests comprises applying a test with one or more thresholds indicative of a high risk country cash advance scenario for the corresponding lending financial product.

Example 46 includes the subject matter of any of Examples 24-45, and further including obtaining, by the compute device, an adjusted threshold for at least one of the tests; and updating, by the compute device, the at least one of the tests with the adjusted threshold.

Example 47 includes one or more machine-readable storage media comprising a plurality of instructions stored thereon that, in response to being executed, cause a compute device to obtain financial transaction data indicative of financial transactions associated with one or more lending financial products of a financial institution; apply, as a function of a corresponding lending financial product associated with the financial transactions, one or more tests to the obtained financial transaction data to detect risk exposure; and generate, in response to a determination that risk exposure has been detected, an alert to enable a human reviewer to evaluate the corresponding financial transaction data.

Example 48 includes the subject matter of Example 47, and wherein to obtain financial transaction data comprises to obtain financial transaction data for a corporate loan or a retail loan.

Example 49 includes the subject matter of any of Examples 47 and 48, and wherein to obtain financial transaction data for a corporate loan comprises to obtain financial transaction data for a commercial loan, an equipment loan, or vendor finance.

Example 50 includes the subject matter of any of Examples 47-49, and wherein to obtain financial transaction data for a retail loan comprises to obtain financial transaction data for an automobile loan, a business loan, a personal loan, a home equity loan, a mortgage loan, a construction loan, or a student loan.

Example 51 includes the subject matter of any of Examples 47-50, and wherein to obtain financial transaction data comprises to obtain financial transaction data for a corporate line of credit or a retail line of credit.

Example 52 includes the subject matter of any of Examples 47-51, and wherein to obtain financial transaction data for a corporate line of credit comprises to obtain financial transaction data for a business credit card, a line of credit card, a commercial credit line, asset based lending, or a letter of credit.

Example 53 includes the subject matter of any of Examples 47-52, and wherein to obtain financial transaction data for a retail line of credit comprises to obtain financial transaction data for a consumer credit card, a line of credit card, a business line of credit, a home equity line of credit, or a personal line of credit.

Example 54 includes the subject matter of any of Examples 47-53, and wherein the instructions additionally cause the compute device to obtain party attribute data indicative of one or more attributes of at least one party to the financial transactions and wherein to apply one or more tests to the obtained financial transactions data comprises to apply the one or more tests additionally to the party attribute data to detect risk exposure.

Example 55 includes the subject matter of any of Examples 47-54, and wherein to apply, as a function of a corresponding lending financial product, one or more tests comprises to apply one or more tests with at least one risk threshold defined as a function of the corresponding financial product.

Example 56 includes the subject matter of any of Examples 47-55, and wherein to apply, as a function of a corresponding lending financial product, one or more tests comprises to apply one or more tests with at least one risk threshold defined as a function of an attribute of a party to one or more of the corresponding financial transactions.

Example 57 includes the subject matter of any of Examples 47-56, and wherein to apply one or more tests with at least one risk threshold defined as a function of an attribute of a party comprises to apply one or more tests with at least one risk threshold defined as a function of a risk rating associated with a customer.

Example 58 includes the subject matter of any of Examples 47-57, and wherein to apply one or more tests with at least one risk threshold defined as a function of an attribute of a party comprises to apply one or more tests with at least one risk threshold defined as a function of whether the party is an organization or an individual.

Example 59 includes the subject matter of any of Examples 47-58, and wherein to apply one or more tests with at least one risk threshold defined as a function of an attribute of a party comprises to apply one or more tests with at least one risk threshold defined as a function of a geographic location of the party.

Example 60 includes the subject matter of any of Examples 47-59, and wherein the party is a merchant and wherein to apply one or more tests with at least one risk threshold defined as a function of an attribute of the party comprises to apply one or more tests with at least one risk threshold defined as a function of a category of business operations of the merchant.

Example 61 includes the subject matter of any of Examples 47-60, and wherein to apply one or more tests comprises to apply a test with one or more thresholds indicative of an early payoff scenario for the corresponding lending financial product.

Example 62 includes the subject matter of any of Examples 47-61, and wherein to apply one or more tests comprises to apply a test with one or more thresholds indicative of an accelerated paydown scenario for the corresponding lending financial product.

Example 63 includes the subject matter of any of Examples 47-62, and wherein to apply one or more tests comprises to apply a test with one or more thresholds indicative of an excessive credit balance refund scenario for the corresponding lending financial product.

Example 64 includes the subject matter of any of Examples 47-63, and wherein to apply one or more tests comprises to apply a test with one or more thresholds indicative of a structured cash scenario for the corresponding lending financial product.

Example 65 includes the subject matter of any of Examples 47-64, and wherein to apply one or more tests comprises to apply a test with one or more thresholds indicative of a significant cash payment scenario for the corresponding lending financial product.

Example 66 includes the subject matter of any of Examples 47-65, and wherein to apply one or more tests comprises to apply a test with one or more thresholds indicative of a multiple loan scenario for the corresponding lending financial product.

Example 67 includes the subject matter of any of Examples 47-66, and wherein to apply one or more tests comprises to apply a test with one or more thresholds indicative of a credit card purchases at high risk merchants scenario for the corresponding lending financial product.

Example 68 includes the subject matter of any of Examples 47-67, and wherein to apply one or more tests comprises to apply a test with one or more thresholds indicative of a high risk country cash advance scenario for the corresponding lending financial product.

Example 69 includes the subject matter of any of Examples 47-68, and wherein the circuitry is further configured to obtain an adjusted threshold for at least one of the tests; and update the at least one of the tests with the adjusted threshold.

1. A compute device comprising:
circuitry configured to:
obtain financial transaction data indicative of financial transactions associated with one or more lending financial products of a financial institution;
apply, as a function of a corresponding lending financial product associated with the financial transactions, one or more tests to the obtained financial transaction data to detect risk exposure; and
generate, in response to a determination that risk exposure has been detected, an alert to enable a human reviewer to evaluate the corresponding financial transaction data.

2. The compute device of claim 1, wherein the circuity is further configured to obtain party attribute data indicative of one or more attributes of at least one party to the financial transactions and wherein to apply one or more tests to the obtained financial transactions data comprises to apply the one or more tests additionally to the party attribute data to detect risk exposure.

3. The compute device of claim 1, wherein to apply, as a function of a corresponding lending financial product, one or more tests comprises to apply one or more tests with at least one risk threshold defined as a function of the corresponding financial product.

4. The compute device of claim 3, wherein to apply, as a function of a corresponding lending financial product, one or more tests comprises to apply one or more tests with at least one risk threshold defined as a function of an attribute of a party to one or more of the corresponding financial transactions.

5. The compute device of claim 4, wherein to apply one or more tests with at least one risk threshold defined as a function of an attribute of a party comprises to apply one or more tests with at least one risk threshold defined as a function of a risk rating associated with a customer.

6. The compute device of claim 4, wherein to apply one or more tests with at least one risk threshold defined as a function of an attribute of a party comprises to apply one or more tests with at least one risk threshold defined as a function of whether the party is an organization or an individual.

7. The compute device of claim 4, wherein to apply one or more tests with at least one risk threshold defined as a function of an attribute of a party comprises to apply one or more tests with at least one risk threshold defined as a function of a geographic location of the party.

8. The compute device of claim 4, wherein the party is a merchant and wherein to apply one or more tests with at least one risk threshold defined as a function of an attribute of the party comprises to apply one or more tests with at least one risk threshold defined as a function of a category of business operations of the merchant.

9. The compute device of claim 1, wherein to apply one or more tests comprises to apply a test with one or more thresholds indicative of one or more of: (i) an early payoff scenario for the corresponding lending financial product; (ii) an accelerated paydown scenario for the corresponding lending financial product; (iii) an excessive credit balance refund scenario for the corresponding lending financial product; (iv) a structured cash scenario for the corresponding lending financial product; (v) a significant cash payment scenario for the corresponding lending financial product; (vi) a multiple loan scenario for the corresponding lending financial product; (vii) a credit card purchases at high risk merchants scenario for the corresponding lending financial product; (viii) a high risk country cash advance scenario for the corresponding lending financial product.

10. The compute device of claim 1, wherein the circuitry is further configured to:
obtain an adjusted threshold for at least one of the tests; and
update the at least one of the tests with the adjusted threshold.

11. A method comprising:
obtaining, by a compute device, financial transaction data indicative of financial transactions associated with one or more lending financial products of a financial institution;
applying, by the compute device and as a function of a corresponding lending financial product associated with the financial transactions, one or more tests to the obtained financial transaction data to detect risk exposure; and
generating, by the compute device and in response to a determination that risk exposure has been detected, an alert to enable a human reviewer to evaluate the corresponding financial transaction data.

12. The method of claim 11, further comprising obtaining, by the compute device, party attribute data indicative of one or more attributes of at least one party to the financial transactions and wherein applying one or more tests to the obtained financial transactions data comprises applying the one or more tests additionally to the party attribute data to detect risk exposure.

13. The method of claim 12, wherein applying, as a function of a corresponding lending financial product, one or more tests comprises applying one or more tests with at least one risk threshold defined as a function of the corresponding financial product.

14. The method of claim 13, wherein applying, as a function of a corresponding lending financial product, one or more tests comprises applying one or more tests with at least one risk threshold defined as a function of an attribute of a party to one or more of the corresponding financial transactions.

15. The method of claim 14, wherein applying one or more tests with at least one risk threshold defined as a function of an attribute of a party comprises applying one or more tests with at least one risk threshold defined as a function of a risk rating associated with a customer.

16. The method of claim 14, wherein applying one or more tests with at least one risk threshold defined as a function of an attribute of a party comprises applying one or more tests with at least one risk threshold defined as a function of whether the party is an organization or an individual.

17. The method of claim 14, wherein applying one or more tests with at least one risk threshold defined as a function of an attribute of a party comprises applying one or more tests with at least one risk threshold defined as a function of a geographic location of the party.

18. The method of claim 14, wherein the party is a merchant and wherein applying one or more tests with at least one risk threshold defined as a function of an attribute of the party comprises applying one or more tests with at least one risk threshold defined as a function of a category of business operations of the merchant.

19. The method of claim 11, wherein applying one or more tests comprises applying a test with one or more thresholds indicative of one or more of: (i) an early payoff scenario for the corresponding lending financial product; (ii) an accelerated paydown scenario for the corresponding lending financial product; (iii) an excessive credit balance refund scenario for the corresponding lending financial product; (iv) a structured cash scenario for the corresponding lending financial product; (v) a significant cash payment scenario for the corresponding lending financial product; (vi) a multiple loan scenario for the corresponding lending financial product;
(vii) a credit card purchases at high risk merchants scenario for the corresponding lending financial product; and/or (viii) a high risk country cash advance scenario for the corresponding lending financial product.

20. One or more machine-readable storage media comprising a plurality of instructions stored thereon that, in response to being executed, cause a compute device to:
obtain financial transaction data indicative of financial transactions associated with one or more lending financial products of a financial institution;
apply, as a function of a corresponding lending financial product associated with the financial transactions, one or more tests to the obtained financial transaction data to detect risk exposure; and
generate, in response to a determination that risk exposure has been detected, an alert to enable a human reviewer to evaluate the corresponding financial transaction data.
